(19) United States
(12) Patent Application Publication
(10) Pub. No.: US 2025/0137975 A1
(43) Pub. Date: May 1, 2025

(54) ULTRASONIC INSPECTION DEVICE AND ULTRASONIC INSPECTION METHOD

(71) Applicant: Hitachi Power Solutions Co., Ltd., Ibaraki (JP)

(72) Inventors: Mutsumi SUZUKI, Tokyo (JP); Shigeru OHNO, Ibaraki (JP)

(21) Appl. No.: 18/918,575

(22) Filed: Oct. 17, 2024

(30) Foreign Application Priority Data
Oct. 30, 2023 (JP) 2023-185484

(51) Int. Cl. G01N 29/28; G01N 29/06; G01N 29/24; G01N 29/265

(52) U.S. Cl. CPC G01N 29/28; G01N 29/069; G01N 29/2437; G01N 29/265; G01N 2291/023; G01N 2291/0289; G01N 2291/101

(57) ABSTRACT

An ultrasonic inspection device includes a scanning measurement device and a control device. The scanning measurement device includes a transmission probe of a line focus type that emits an ultrasonic beam and reception probes and that receive the ultrasonic beam. The transmission probe emits an ultrasonic beam by being applied with a voltage waveform of a periodic wave packet including a wave packet having a wavenumber of equal to or greater than 2. The transmission probe is driven at an excitation frequency higher than a resonance frequency of the transmission probe. A signal processing unit of the control device includes a filter unit that reduces at least a maximum intensity frequency component in a reception signal of the reception probes and detects a skirt component other than the maximum intensity frequency component in the fundamental waveband including the maximum intensity frequency component.

### CROSS-REFERENCE TO RELATED APPLICATION

The present application claims priority from Japanese application JP2023-185484, filed on Oct. 30, 2023, the content of which is hereby incorporated by reference into this application.

### TECHNICAL FIELD

The present disclosure relates to an ultrasonic inspection device and an ultrasonic inspection method.

### BACKGROUND ART

An inspection method of a defect portion of an inspection object using an ultrasonic beam is known. For example, when there is a defect portion (cavity or the like) having small acoustic impedance such as air inside the inspection object, a gap of the acoustic impedance occurs inside the inspection object, and therefore the transmission amount of the ultrasonic beam becomes small. Therefore, by measuring the transmission amount of the ultrasonic beam, it is possible to detect the defect portion inside the inspection object.

A technique described in PTL 1 is known regarding an ultrasonic inspection device. In the ultrasonic inspection device described in PTL 1, a rectangular wave burst signal composed of a predetermined number of consecutive negative rectangular waves is applied to a transmission ultrasonic wave probe arranged facing a test object via air. A reception ultrasonic probe disposed facing the test object via air converts an ultrasonic wave propagated through the test object into a transmitted wave signal. The presence or absence of a defect of the test object is determined based on the signal level of this transmitted wave signal. In the transmission ultrasonic wave probe and the reception ultrasonic probe, the acoustic impedance of a transducer and a front plate attached to a transmission/reception side of the ultrasonic wave of the transducer is set lower than that of a contact type ultrasonic probe used in contact with the test object.

### CITATION LIST

### Patent Literature

PTL 1: JP 2008-128965 A

### SUMMARY OF INVENTION

### Technical Problem

The ultrasonic inspection device described in PTL 1 has a problem that it is difficult to detect a minute defect in an inspection object. In particular, when the size of the defect to be detected is smaller than that of the ultrasonic beam, it is difficult to detect the defect. A problem to be solved by the present disclosure is to provide an ultrasonic inspection device and an ultrasonic inspection method that have a detection performance of a defect portion, for example, a small detectable defect size and can detect even a minute defect.

### Solution to Problem

An ultrasonic inspection device of the present disclosure is an ultrasonic inspection device that performs inspection of an inspection object by causing an ultrasonic beam to be inject on the inspection object via a fluid, the ultrasonic inspection device including: a scanning measurement device that performs scanning and measurement of the ultrasonic beam on the inspection object; and a control device that controls drive of the scanning measurement device, in which the scanning measurement device includes a transmission probe of a line focus type that emits the ultrasonic beam, and a reception probe that receives the ultrasonic beam, the reception probe being installed on an opposite side of the transmission probe with respect to the inspection object, the transmission probe emits an ultrasonic beam by being applied with a voltage waveform of a periodic wave packet including a wave packet having a wavenumber of equal to or greater than 2, and drives the transmission probe at an excitation frequency higher than a resonance frequency of the transmission probe, the control device includes a signal processing unit, the signal processing unit includes a filter unit that reduces at least a maximum intensity frequency component of a reception signal of the reception probe, and the filter unit detects a skirt component other than the maximum intensity frequency component in a fundamental waveband including the maximum intensity frequency component. Other solutions will be described later in Description of Embodiments.

### Advantageous Effects of Invention

According to the present disclosure, it is possible to provide an ultrasonic inspection device and an ultrasonic inspection method that have a detection performance of a defect portion, for example, a small detectable defect size and can detect even a minute defect.

### BRIEF DESCRIPTION OF DRAWINGS

FIG. 1 is a view illustrating a configuration of an ultrasonic inspection device of a first embodiment.

FIG. 2 is a view schematically illustrating a transmission sound axis in a case of a transmission probe of a point focus type.

FIG. 3 is a view schematically illustrating a transmission sound axis surface in a case of a transmission probe of a line focus type.

FIG. 4A is a schematic cross-sectional view illustrating a structure of a transmission probe, the view being viewed from a y-axis direction.

FIG. 4B is a schematic cross-sectional view illustrating a structure of the transmission probe, the view being viewed from an x-axis direction.

FIG. 5 is a view describing a long axis and a scanning direction of the transmission probe.

FIG. 6 is a view describing a long axis and a scanning direction of a transmission probe in another embodiment.

FIG. 7A is a view illustrating a propagation path of an ultrasonic beam in a conventional ultrasonic inspection method, the view illustrating at the time of injection to a normal portion.

FIG. 7B is a view illustrating a propagation path of an ultrasonic beam in a conventional ultrasonic inspection method, the view illustrating at the time of injection to a defect portion.

FIG. 8A is a view illustrating an interaction between a defect portion and an ultrasonic beam in an inspection object E, the view illustrating a scene of receiving a ultrasonic beam that directly reaches as viewed from the side.

FIG. 8B is a view illustrating an interaction between the defect portion and the ultrasonic beam in the inspection object E, the view illustrating a scene of receiving the ultrasonic beam that directly reaches as viewed from above.

FIG. 9A is a view schematically illustrating a scattering wave that is an ultrasonic beam interacting with the defect portion, the view of the scattering wave viewed from the side.

FIG. 9B is a view schematically illustrating a scattering wave that is an ultrasonic beam interacting with the defect portion, the view of the scattering wave viewed from above.

FIG. 10 is a functional block diagram of a control device.

FIG. 11 is a view illustrating signal intensity when a transmission probe and a reception probe are scanned so as to cross a defect portion in an inspection object.

FIG. 12 is a view illustrating an example of a spectrum of a reception signal observed in the present embodiment.

FIG. 13 is a view schematically illustrating a distribution (frequency spectrum) of frequency components of a reception signal.

FIG. 14 is a voltage waveform of a burst wave to be applied to the transmission probe.

FIG. 15A illustrates a frequency spectrum of a transmission ultrasonic wave when a wavenumber is changed.

FIG. 15B is a frequency spectrum in a case where the wavenumber is 3 (broken line), 5 (solid line), or 10 (dash-dot line).

FIG. 16 is a view schematically illustrating a frequency spectrum of a fundamental waveband.

FIG. 17 is a view illustrating a relationship between a full-width of half maximum ratio (FWHM ratio) of a fundamental waveband and a wavenumber.

FIG. 18A illustrates frequency characteristics of a gain in a bandstop filter.

FIG. 18B is a view schematically illustrating frequency characteristics of a signal after being processed by the bandstop filter.

FIG. 19A illustrates frequency characteristics of a gain in a low-pass filter.

FIG. 19B is a view schematically illustrating frequency characteristics of a signal after being processed by the low-pass filter.

FIG. 20A illustrates frequency characteristics of a gain in a high-pass filter.

FIG. 20B is a view schematically illustrating frequency characteristics of a signal after being processed by the high-pass filter.

FIG. 21 is a block diagram illustrating a filter unit of a digital method.

FIG. 22 is a block diagram illustrating a filter unit according to another embodiment.

FIG. 23A is a frequency spectrum of a wavenumber of a wave packet and a fundamental waveband of a ultrasonic beam thereof.

FIG. 23B is a view illustrating how the full-width of half maximum of the fundamental waveband of the spectrum illustrated in FIG. 23A changes with respect to a wavenumber N0 of the wave packet.

FIG. 24 is a functional block diagram of a control device in an ultrasonic inspection device of a second embodiment.

FIG. 25 is a functional block diagram of a control device in an ultrasonic inspection device of a third embodiment.

FIG. 26 is a functional block diagram of a control device in an ultrasonic inspection device of a fourth embodiment.

FIG. 27A is a view schematically illustrating a propagation path of an ultrasonic beam in a case where a focal length of a transmission probe and a focal length of a reception probe are equal to each other in a fifth embodiment.

FIG. 27B is a view schematically illustrating a propagation path of an ultrasonic beam in a case where the focal length of the reception probe is longer than the focal length of the transmission probe in the fifth embodiment.

FIG. 28 is a view describing a relationship between a beam injection area in a transmission probe and a beam injection area in a reception probe.

FIG. 29 is a view illustrating a configuration of an ultrasonic inspection device of a sixth embodiment.

FIG. 30 is a plan view illustrating a relative positional relationship between a transmission probe and a reception probe.

FIG. 31 is a functional block diagram of a control device in an ultrasonic inspection device of a sixth embodiment.

FIG. 32A is a view describing a transmission sound axis, a reception sound axis, and an eccentric distance, and it is a case where the transmission sound axis and the reception sound axis extend in a vertical direction.

FIG. 32B is a view describing a transmission sound axis, a reception sound axis, and an eccentric distance, and it is a case where the transmission sound axis and the reception sound axis extend in an inclined manner.

FIG. 33 is a view illustrating a configuration of an ultrasonic inspection device of a seventh embodiment.

FIG. 34 is a view describing a reason for an effect by the seventh embodiment to occur.

FIG. 35 is a view illustrating a configuration of an ultrasonic inspection device of an eighth embodiment.

FIG. 36 is a plan view illustrating a positional relationship between a reception probe and an acoustic wave shielding member.

FIG. 37 is a view illustrating a configuration of a signal processing unit of a ninth embodiment.

FIG. 38 is a plan view illustrating a positional relationship between an ultrasonic beam emitted from a transmission probe of a line focus type and an ultrasonic beam emitted from a transmission probe of a point focus type.

FIG. 39A is a view illustrating an imaging process of a defect image.

FIG. 39B is a view illustrating a process performed subsequent to the process illustrated in FIG. 39A.

FIG. 39C is a view illustrating a process performed subsequent to the process illustrated in FIG. 39B.

FIG. 40 is a view illustrating a configuration of a transmission probe of a line focus type in a tenth embodiment.

FIG. 41 is a timing chart illustrating a drive sequence in a configuration using two unit probes.

FIG. 42 is a timing chart illustrating a drive sequence in another embodiment related to the tenth embodiment.

FIG. 43 is a functional block diagram of a control device of an eleventh embodiment.

FIG. 44A is an example of a database.

FIG. 44B is a view three-dimensionally illustrating the database illustrated in FIG. 44A.

FIG. 45 is a view schematically illustrating a configuration example of an operation screen of an ultrasonic inspection device in an example of the present disclosure.

FIG. 46 is a functional block diagram of an ultrasonic inspection device of a twelfth embodiment.

FIG. 47 is a view illustrating a configuration of an ultrasonic inspection device of a thirteenth embodiment.

FIG. 48 is a view illustrating a hardware configuration of a control device.

FIG. 49 is a flowchart showing an ultrasonic inspection method of each embodiment.

### DESCRIPTION OF EMBODIMENTS

Hereinafter, modes (called embodiments) for carrying out the present disclosure will be described below with reference to the drawings. In the following description of one embodiment, another embodiment applicable to the one embodiment will also be described as appropriate. The present disclosure is not limited to the following one embodiment, and different embodiments may be combined or may be modified in any manner as long as the effects of the present disclosure are not significantly impaired. The same members are denoted by the same reference signs, and redundant description will be omitted. Furthermore, those having the same function are denoted by the same name. Illustrated content is merely schematic, and for convenience of illustration, it may be changed from an actual configuration within a range not significantly impairing the effects of the present disclosure, or illustration of some members may be omitted or modified among the drawings. The same embodiment does not necessarily need to include all the configurations.

### First Embodiment

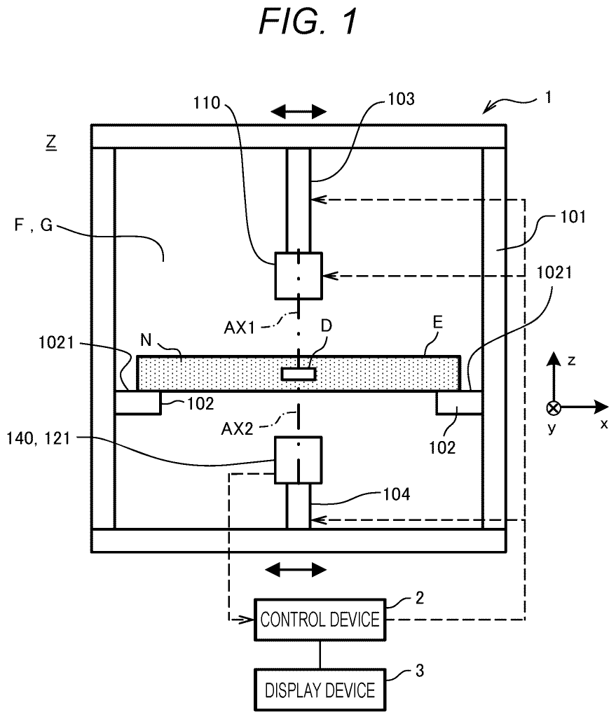

FIG. 1 is a view illustrating the configuration of an ultrasonic inspection device Z of the first embodiment. In FIG. 1, a scanning measurement device 1 is illustrated in a schematic cross-sectional view. FIG. 1 illustrates a coordinate system of orthogonal three axes including the x-axis as a left-right direction on the paper surface, the y-axis as an orthogonal direction on the paper surface, and the z-axis as an up-down direction on the paper surface.

The ultrasonic inspection device Z inspects the inspection object E by injecting an ultrasonic beam U (described later) to the inspection object E via a fluid F. The fluid F is a liquid W (described later) such as water, for example, or a gas G such as air, and the inspection object E exists in the fluid F. In the first embodiment, the fluid F is air (an example of the gas G). Therefore, the inside of a housing 101 of the scanning measurement device 1 is a cavity filled with air. As illustrated in FIG. 1, the ultrasonic inspection device Z includes the scanning measurement device 1, a control device 2, and a display device 3. The display device 3 is connected to the control device 2.

The scanning measurement device 1 performs scanning and measurement of the ultrasonic beam U on the inspection object E, and includes a sample stage 102 fixed to the housing 101, and the inspection object E is placed on the sample stage 102. The inspection object E is more preferably fixed to the sample stage 102 with a fixture (not illustrated) so as not to move. In a case where the inspection object E is sufficiently heavy, does not improperly move, or the like, the fixture may be omitted. The inspection object E is made of an arbitrary material. The inspection object E is, for example, a solid material, and more specifically, for example, metal, glass, a resin material, a composite material such as carbon-fiber reinforced plastics (CFRP), or the like. In the example of FIG. 1, the inspection object E internally includes a defect portion D. The defect portion D (defect) is a cavity or the like. Examples of the defect portion D include a cavity and a foreign material different from a material to be originally intended. In the inspection object E, a part other than the defect portion D is called a normal portion N.

Since the defect portion D and the normal portion N are made of different materials, the acoustic impedance is different between them, and the propagation characteristics of the ultrasonic beam U change. The ultrasonic inspection device Z observes this change to detect the defect portion D.

The scanning measurement device 1 includes a transmission probe 110 of a line focus type (line convergence type. Definitions will be described later) that emits the ultrasonic beam U and a reception probe 121 that receives the ultrasonic beam U. The transmission probe 110 is installed in the housing 101 via a transmission probe scanning unit 103 and emits the ultrasonic beam U. Although described in detail later, the transmission probe 110 emits the ultrasonic beam U by being applied with a voltage waveform of a periodic wave packet including a wave packet having a wavenumber N0 of equal to or greater than 2. The transmission probe 110 is driven at an excitation frequency fex higher than a resonance frequency (natural frequency fres) of the transmission probe 110.

The reception probe 121 is a reception probe 140 (coaxial arrangement reception probe) installed on the opposite side of the transmission probe 110 with respect to the inspection object E to receive the ultrasonic beam U, and coaxially arranged with the transmission probe 110 (an eccentric distance L described later is zero). Therefore, in the present disclosure, the eccentric distance L (distance. Described later) between a transmission sound axis surface AX1 (sound axis) of the transmission probe 110 and a reception sound axis AX2 (sound axis) of the reception probe 140 is zero. This can easily install the transmission probe 110 and the reception probe 140.

Here, the “opposite side of the transmission probe 110” means, of two spaces divided by the inspection object E, a space on the opposite side (opposite side in the z-axis direction) to the space where the transmission probe 110 is positioned, and does not mean that the x and y coordinates are limited to the same opposite side (i.e., the position of plane symmetry with respect to the xy plane).

At the time of scanning in a direction perpendicular to the long axis direction of the ultrasonic beam U using the transmission probe 110 of a line focus type as in the present example, a wider area is irradiated with the ultrasonic beam U as compared with the case of using a transmission probe 119 (described later) of a point focus type (Point convergence type. Described later). Use of the transmission probe 110 of a line focus type can significantly shorten the time required for inspection. That is, since a wide sweep area S can be scanned at once, measurement can be significantly sped up.

On the other hand, use of the transmission probe 110 of a line focus type tends to make it difficult to detect a minute defect portion D. By using the configuration described later, the present example can detect the minute defect portion D even by using the transmission probe 110 of a line focus type. Hereinafter, the transmission probe 110 that is simply mentioned represents a transmission probe of a line focus type.

In the example of the present disclosure, the transmission probe 110 is installed such that the transmission sound axis surface AX1 of the transmission probe 110 is perpendicular to a placement surface 1021 of the sample stage 102. That is, the transmission probe 110 is installed such that the transmission sound axis surface AX1 is in a normal direction of the placement surface 1021 of the inspection object E of the sample stage 102. By doing this, in the inspection object E having a plate shape, since the transmission sound axis surface AX1 is arranged perpendicularly on the surface of the inspection object E, there is an effect that the correspondence relationship between the scanning position and the position of the defect portion D is easily understood.

Here, the sound axis and the transmission sound axis surface are defined as described later.

However, the present disclosure is not limited to installing the transmission probe 110 such that the transmission sound axis surface AX1 is perpendicular to the placement surface 1021 of the inspection object E of the sample stage 102. Even when the transmission sound axis surface AX1 is not perpendicular to the placement surface 1021 of the inspection object E of the sample stage 102, the effect of the present disclosure is obtained. In the latter case, in order to accurately know the position of the defect portion D, the path of the transmission sound axis surface AX1 may be calculated in accordance with an inclination of the transmission sound axis surface AX1 from the perpendicular direction.

Here, the positional relationship between the transmission probe 110 and the reception probe 121 will be described. The distance between the transmission sound axis surface AX1 of the transmission probe 110 and the reception sound axis AX2 of the reception probe 121 is defined as the eccentric distance L as described above. In the present disclosure, as described above, the eccentric distance L is set to zero. That is, the reception probe 121 is arranged such that the transmission sound axis surface AX1 and the reception sound axis AX2 are coaxial. This is called coaxial arrangement. Note that in the present disclosure, the eccentric distance L is not limited to zero.

In the present disclosure, as the arrangement position of the reception probe 121, the arrangement in which the transmission sound axis surface AX1 and the reception sound axis AX2 are coaxially arranged is called coaxial arrangement, and the arrangement in which the two sound axes (the transmission sound axis surface AX1 and the reception sound axis AX2) are shifted (i.e., eccentrically arranged) is called eccentric arrangement. The present disclosure is effective in both causes of a case where the reception probe 121 is coaxially arranged and a case where the reception probe is eccentrically arranged. Therefore, the present disclosure includes both coaxial arrangement and eccentric arrangement as the arrangement of the reception probe 121. A specific illustration of the eccentric arrangement will be described later.

In the present disclosure, in particular, when a reception arrangement position is designated, the reception probe 121 coaxially arranged is called the reception probe 140 (coaxial arrangement reception probe), and the reception probe 121 eccentrically arranged is called a reception probe 120 (eccentric arrangement reception probe. Described later).

When written as the reception probe 121, whether to be coaxial arrangement or eccentric arrangement is not particularly designated.

### (Sound Axis and Transmission Sound Axis Surface)

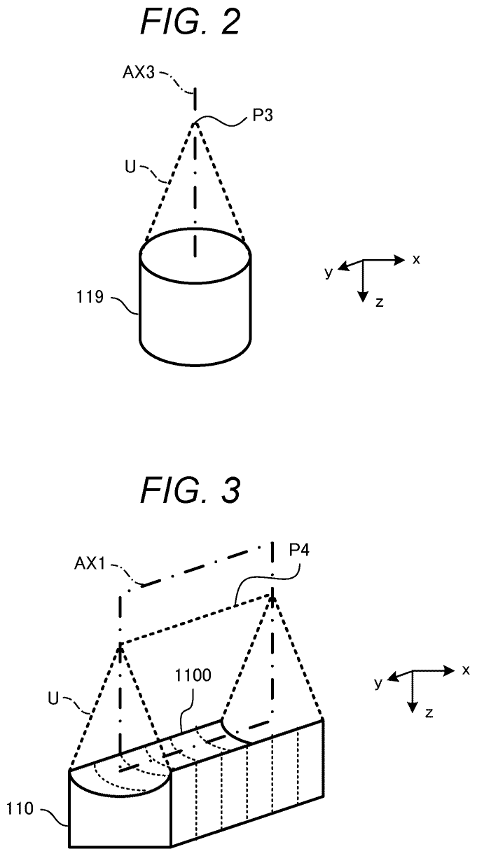

FIG. 2 is a view schematically illustrating a transmission sound axis AX3 in the case of the transmission probe 119 of a point focus type. The sound axis is defined as a center axis of the ultrasonic beam U. Here, in the case of the transmission probe 119 of a point focus type, the transmission sound axis AX3 is defined as a sound axis of a propagation path of the ultrasonic beam U emitted by the transmission probe 119. In other words, the transmission sound axis AX3 is the center axis of the propagation path of the ultrasonic beam U emitted by the transmission probe 119. In the case of the ultrasonic beam U of a point convergence type, a convergence point P3 of the ultrasonic beam U is positioned on the transmission sound axis AX3.

FIG. 3 is a view schematically illustrating the transmission sound axis surface AX1 in the case of the transmission probe 110 of a line focus type. As indicated by the dotted line in FIG. 3, a virtual element 1100 is assumed by virtually dividing the transmission probe 110 in the long axis direction. When the division width is sufficiently small, the virtual element 1100 can be considered similarly to the transmission probe 119 of a point focus type, and in the virtual element 1100, although none is illustrated in FIG. 3, the transmission sound axis AX3 and the convergence point P3 on the transmission sound axis AX3 are formed. However, the beam emitted from the virtual element 1100 does not converge in the y-axis direction, and therefore this point is different from the point focus type.

A surface on which an aggregate of the transmission sound axes AX3 of the virtual elements 1100 stretches is defined as the transmission sound axis surface AX1. The long axis direction mentioned here is a direction perpendicular to the emitting direction (−z-direction in the illustrated example) of the ultrasonic beam U, and is a direction (±y-direction in the illustrated example) at the same height position on the probe surface. In the case of the transmission probe 110, a convergence line P4 of the ultrasonic beam U is positioned on the transmission sound axis surface AX1. The convergence line P4 is an aggregate of the convergence points P3 formed by the virtual elements 1100.

As described later, the transmission sound axis surface AX1 includes refraction due to an interface of the inspection object E. That is, when the ultrasonic beam U emitted from the transmission probe 110 is refracted at the interface of the inspection object E, the center (sound axis) of the propagation path of the ultrasonic beam U becomes the transmission sound axis surface AX1.

Note that the physical properties of the ultrasonic beam U that is emitted are the same in both the transmission probe 110 of a line focus type and the transmission probe of a point focus type 119.

Returning to FIG. 1, the reception sound axis AX2 is defined as a sound axis of a propagation path of the virtual ultrasonic beam U (virtual ultrasonic beam) on an assumption that the reception probe 121 emits the ultrasonic beam U. In other words, the reception sound axis AX2 is a center axis of the virtual ultrasonic beam on an assumption that the reception probe 121 emits the ultrasonic beam U.

As a specific example, a case of the reception probe 121 of a non-convergence type whose probe surface is planar will be described. In this case, the direction of the reception sound axis AX2 is the normal direction of the probe surface, and the axis passing through the center point of the probe surface is the reception sound axis AX2. When the probe surface is rectangular, the center point is defined as an intersection point of diagonal lines of the rectangle.

The control device 2 is connected to the scanning measurement device 1. The control device 2 controls drive of the scanning measurement device 1, and controls movement (scanning) of the transmission probe 110 and the reception probe 121 by instructing the transmission probe scanning unit 103 and the reception probe scanning unit 104. The transmission probe scanning unit 103 and the reception probe scanning unit 104 move in the x-axis direction and the y-axis direction in synchronization with each other, whereby the transmission probe 110 and the reception probe 121 scan the inspection object E in the x-axis direction and the y-axis direction. Furthermore, the control device 2 emits the ultrasonic beam U from the transmission probe 110 and performs waveform analysis based on a signal acquired from the reception probe 121. Note that a plane formed by two axes in the x-axis direction and the y-axis direction, which are scanning directions of the transmission probe 110, will be called a scan plane.

Note that the present disclosure illustrates an example of scanning the transmission probe 110 and the reception probe 121 in a state where the inspection object E is fixed to the housing 101 via the sample stage 102, that is, in a state where the inspection object E is fixed to the housing 101. On the contrary, the transmission probe 110 and the reception probe 121 may be fixed to the housing 101, and may be configured to scan the position of the sample stage 102 in the x-axis and y-axis directions. In this configuration, since the inspection object E placed on the sample stage 102 also moves, the relative position with respect to the transmission probe 110 is scanned in the x-axis and y-axis directions.

In the illustrated example, the gas G (example of the fluid F, and may be the liquid W (described later) is interposed between the transmission probe 110 and the inspection object E and between the reception probe 121 and the inspection object E. Therefore, since the transmission probe 110 and the reception probe 121 can be inspected in a non-contact manner with the inspection object E, the relative position in an xy in-plane direction can be smoothly and quickly changed. That is, by interposing the fluid F (gas G) between the transmission probe 110 and the reception probe 121 and the inspection object E, smooth scanning is possible.

When a local ultrasonic beam U is emitted from the transmission probe 110, the ultrasonic beam U that is emitted is locally emitted to the inspection object E. The position irradiated with the local ultrasonic beam U is changed by scanning. As described above, since the ultrasonic beam U reaching the reception probe 121 changes between the defect portion D and the normal portion N of the inspection object E, the defect portion D can be detected by this configuration.

In order to generate the local ultrasonic beam U, the transmission probe 110 of a line focus type can be used in the present embodiment.

As described above, the transmission probe 110 is of a line focus type. On the other hand, the reception probe 121 is a probe having a convergence looser than that of the transmission probe 110. In the present disclosure, a probe of a non-convergent type having a flat probe surface is used as the reception probe 121. Therefore, the reception probe 121 is a reception probe of a non-convergent type. Use of such the reception probe 121 of a non-convergent type enables information on the defect portion D to be collected for a wide range.

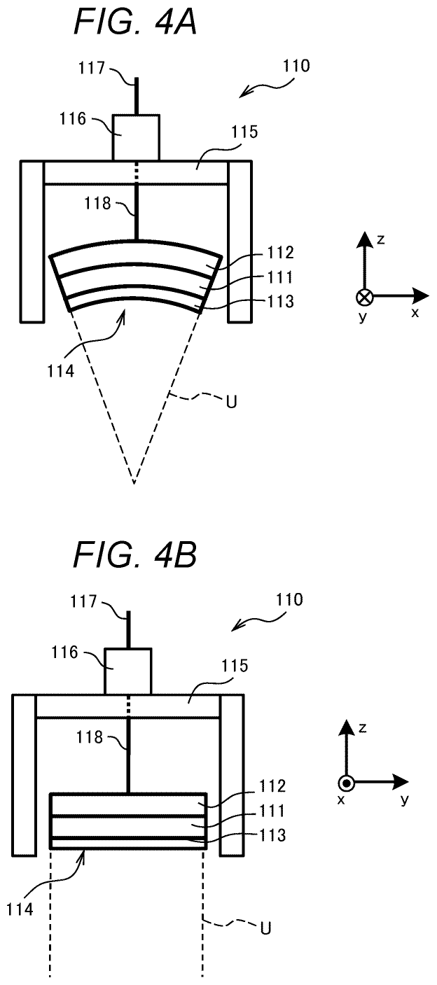

FIG. 4A is a schematic cross-sectional view illustrating the structure of the transmission probe 110, the view being viewed from the y-axis direction FIG. 4B is a schematic cross-sectional view illustrating the structure of the transmission probe, the view being viewed from the x-axis direction. Although FIGS. 4A and 4B only illustrate an outline of the ultrasonic beam U to be emitted for simplification, in reality, a large number of ultrasonic beams U are emitted in a normal vector direction of a probe surface 114 over the entire probe surface 114.

As illustrated in FIG. 4A, the ultrasonic beam U emitted from the transmission probe 110 converges in a certain direction (direction of the x-axis in the example of FIG. 4A), and the ultrasonic beam U does not converge in a direction orthogonal thereto as illustrated in FIG. 4B. As described above, the transmission probe 110 of a line focus type emits the ultrasonic beam U that is linear and converges in one direction at the convergence position (convergence line P4). In the examples of FIGS. 4A and 4B, the ultrasonic beam U becomes a linear ultrasonic beam U extending in the y-direction at the position of the focal length where the ultrasonic beam U converges.

FIGS. 4A and 4B illustrate arrows indicating the x, y, and z-axis directions. Here, according to the general description, “x” represents an arrow from the front side to the back side of the drawing, and a double circle symbol represents an arrow from the back side to the front side of the drawing. Other drawings of the present description illustrate arrows representing this direction as much as possible.

### (Long Axis and Short Axis)

Regarding the shape of the ultrasonic beam U that is converged, the longer side will be called a “long axis” or a “long side”, and the shorter side will be called a “short axis” or a “short side”. In the present description, the long axis and the long side are synonymous. The short axis and the short side also are synonymous. Regarding the shape of the ultrasonic beam U that is converged, the length of the long axis is defined as a longer width (WL), and the width of the short axis is defined as a shorter width (WS).

The “long axis” of the transmission probe 110 is defined as a direction of the long axis of the ultrasonic beam U that is emitted. That is, in the present description, regardless of the shape of the transmission probe 110 itself, the “long axis” is defined by the shape of the ultrasonic beam U that is emitted.

The shape of the ultrasonic beam U (hereinafter, appropriately called a line convergence beam) to line converge is, for example, typically an elongated rectangular shape on an irradiation surface, but may be an elliptical shape. Even in the case of the elliptical shape, the “long axis” and the “short axis” are defined similarly.

In the present description, for the sake of clarity, each view is illustrated with the x-axis direction aligned with the short axis direction of the line convergence beam as illustrated in FIGS. 4A and 4B. Therefore, the y-axis direction is aligned with the long axis direction of the line convergence beam.

### (Scan Axis)

Hereinafter, the scanning direction of the transmission probe 110 is described as a scan axis 131 (described later). The scan axis is preferably a direction substantially orthogonal to the long axis of the transmission probe 110. The term substantially orthogonal as mentioned here includes, in addition to orthogonal, a form of intersection at an angle that can be considered to be similar to orthogonal from the viewpoint of operations and effects, for example. Therefore, an angle θ formed by a long axis 130, which is an axis of the longest part in the convergence portion of the ultrasonic beam U emitted from the transmission probe 110, and the scan axis 131, which is a scanning direction of the transmission probe 110, is preferably equal to or greater than 60° and equal to or less than 1200 with respect to the scanning direction.

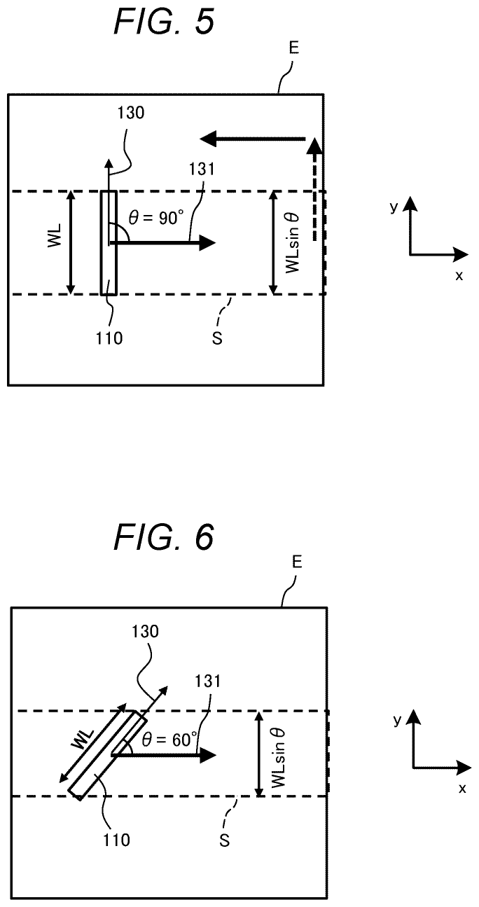

FIG. 5 is a view describing the long axis 130 and the scanning direction of the transmission probe 110. As illustrated in FIG. 5, the angle formed by the long axis 130 and the scan axis 131 of the transmission probe 110 is the angle θ. When the transmission probe 110 moves by Δx in the scanning direction, the sweep area S (scan area) of the ultrasonic beam U in the part irradiated with the ultrasonic beam U with the movement becomes WLsinθ×Δx. The sweep area S is the entire area of the part where the inspection object E is irradiated with the ultrasonic beam U by scanning (sweeping) of the transmission probe 110. Since θ=90° in the case illustrated in FIG. 5, the irradiation portion has a rectangular shape, and S=WL×Δx. Therefore, when θ=90°, the sweep area S is the widest, and the widest area can be inspected, which is preferable.

FIG. 6 is a view describing the long axis 130 and the scanning direction of the transmission probe 110 in another embodiment. In FIG. 6, as an example, the angle θ is 60°. In this case, since sin θ=0.87, the sweep area S is reduced by 13% as compared with the case of θ=90°, and therefore the effect of the present disclosure that the inspection can be performed at high speed can be obtained. That is, even if θ=60°, that is, shifted from the orthogonal by ±30°, it can be considered as “substantially orthogonal”.

Note that as indicated by the solid arrow in FIG. 5, the transmission probe 110 is scanned along the scan axis 131 to reach the +x-axis direction end of the inspection object E, and then, as indicated by the broken arrow, the position of the transmission probe 110 is moved to another y coordinate in the +y-direction. Next, the transmission probe 110 scans in the scan axis direction toward the −x-direction this time. In the present description, the direction of movement to this different y coordinate is called a sub movement axis, and is distinguished from the scan axis. The sub movement axis is preferably orthogonal to the scan axis.

The scanning direction of the transmission probe 110 may be along the scan axis 131, and an orientation of scanning may be either the positive direction or the negative direction. As illustrated in FIG. 5, when the orientation of scanning is alternately the positive direction (+direction) and the negative direction (−direction), the moving distance of the transmission probe 110 can be shortened, which is preferable.

Returning to FIGS. 4A and 4B, the transmission probe 110 of a line focus type is configured to linearly converge the ultrasonic beam U. This can quickly detect the defect portion D in the inspection object E. The transmission probe 110 includes a transmission probe housing 115, and includes a backing 112, a transducer 111, and a matching layer 113 inside the transmission probe housing 115. The transducer 111 is attached with an electrode (not illustrated), and the electrode is connected to a connector 116 by a lead wire 118. Furthermore, the connector 116 is connected to a power source device (not illustrated) and the control device 2 by a lead wire 117.

In the present disclosure, the probe surface 114 of the transmission probe 110 or the reception probe 121 is defined as a surface of the matching layer 113 in a case of including the matching layer 113, and is defined as a surface of the transducer 111 in a case of not including the matching layer 113. That is, the probe surface 114 is a surface that emits the ultrasonic beam U in the case of the transmission probe 110, and is a surface that receives the ultrasonic beam U in the case of the reception probe 121.

Here, as a comparative example, a conventional ultrasonic inspection method will be described.

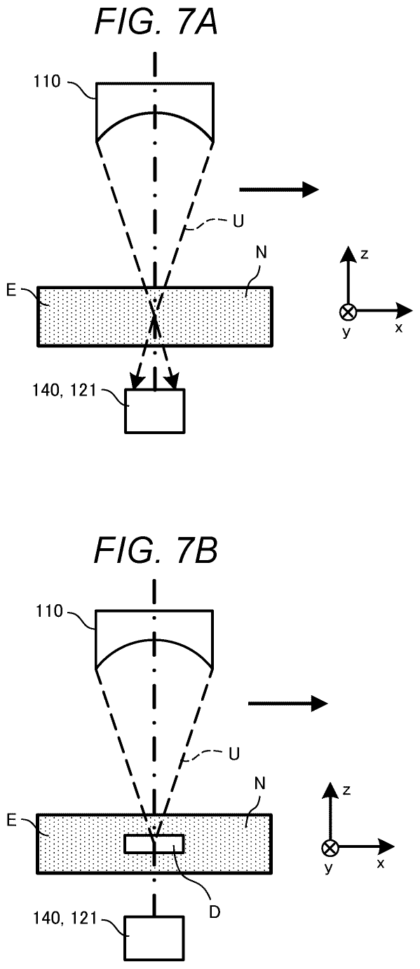

FIG. 7A is a view illustrating a propagation path of the ultrasonic beam U in the conventional ultrasonic inspection method, the view illustrating the time of injection to the normal portion N. FIG. 7B is a view illustrating a propagation path of the ultrasonic beam U in the conventional ultrasonic inspection method, the view illustrating the time of injection to the defect portion D. The thick solid arrows in FIGS. 7A and 7B are the moving direction (scanning direction) of the transmission probe 110. In the conventional ultrasonic inspection method, for example, as described in PTL 1, the transmission probe 110 and the reception probe 140 as the reception probe 121 are arranged such that the transmission sound axis surface AX1 and the reception sound axis AX2 coincide with each other (the reception sound axis AX2 exists in the transmission sound axis surface AX1).

As illustrated in FIG. 7A, when the ultrasonic beam U is injected onto the normal portion N of the inspection object E, the ultrasonic beam U passes through the inspection object E and reaches the reception probe 140. Therefore, the reception signal becomes large. On the other hand, as illustrated in FIG. 7B, when the ultrasonic beam U is injected onto the defect portion D, transmission of the ultrasonic beam U is blocked by the defect portion D, and therefore the reception signal decreases. In this manner, the defect portion D is detected by the decrease in the reception signal. This is as described in PTL 1.

Here, as illustrated in FIGS. 7A and 7B, a method in which transmission of the ultrasonic beam U is blocked at the defect portion D, the reception signal decreases, and the defect portion D is detected will be hereby called a “block method”.

The transmission probe 110 scans in the direction of the scan axis 131 as described above. At the time of scanning, the reception probe 140 is also scanned so as to keep a relative positional relationship between the transmission probe 110 and the reception probe 140. In place of scanning the transmission probe 110 and the reception probe 140, the inspection object E may be scanned. That is, the relative position between the transmission probe 110 and the inspection object E may be scanned.

As described above, the scan axis 131 is in a direction substantially perpendicular to the long axis direction of the transmission probe 110. In the case of FIG. 7A, since the long axis 130 of the transmission probe 110 extends in the y-axis direction, the scan axis 131 extends in the x-axis direction.

Here, the example illustrated in FIG. 5 above will be examined again. FIG. 5 illustrates a case where the inspection object E is disposed parallel to the xy plane. As illustrated in FIG. 3, as the ultrasonic beam U advances in the z-axis direction, the beam width in the x-axis direction narrows and converges, and the x-axis direction becomes the short axis direction. In FIG. 5, the short axis direction of the beam shape of the ultrasonic beam U emitted from the transmission probe 110 is the x-axis direction, and the long axis direction is the y-axis direction. The scan axis 131 is in the x-axis direction. When scanning in this manner, the range of the length WL in the long axis direction of the line convergence beam (the region surrounded by the dotted line in FIG. 5) can be inspected by scanning of one time, and therefore there is an effect of being able to quickly inspect the inspection object E.

However, use of the transmission probe 110 in the conventional method (e.g., the method of PTL 1) had a problem of difficulty in detecting the minute defect portion D. In the block method used in the conventional technique, unless the size of the defect portion D is about half of the irradiation area of the ultrasonic beam U, most of the ultrasonic beam U passes through a place (normal portion N) other than the defect portion D, and therefore the ultrasonic beam U cannot be sufficiently blocked. Therefore, a sufficient signal change amount cannot be obtained.

As an example, a case where the length WL in the long axis direction of the transmission probe 110 is 20 mm will be considered. If a defect has a width of 10 mm, half of the irradiation region of the ultrasonic beam U is blocked, and therefore a sufficient signal change amount can be obtained. However, when the width of the defect portion D is 1 mm, only 1 mm of the region having a length of 20 mm is blocked at the maximum. That is, the signal change amount is 1/20 at most, and it is difficult to detect the signal change amount.

In the present disclosure, it is possible to detect the minute defect portion D using a transmission probe by the method described later. This can achieve both high speed of inspection and detectability of the minute defect portion D. Note that the detection of the minute defect portion D mentioned here means that the presence of the minute defect portion D in the irradiation region of the ultrasonic beam U can be detected, and does not necessarily mean that the xy-direction position of the minute defect portion D is accurately grasped.

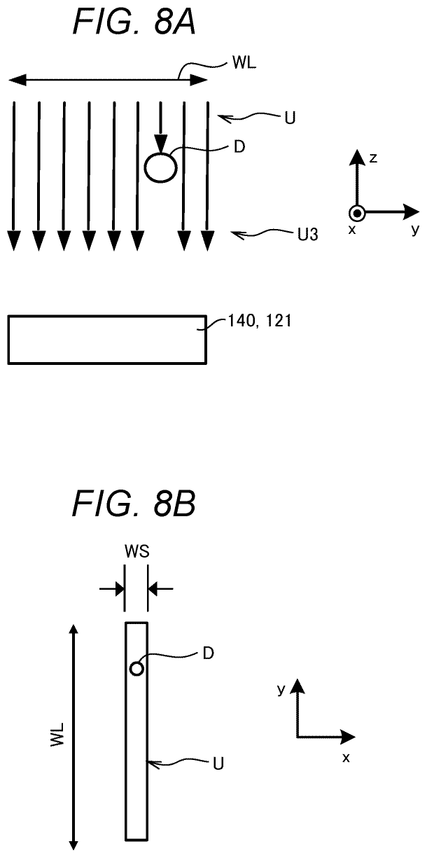

With reference to FIGS. 8A and 8B, a description will be given of a problem in the conventional technique that use of the transmission probe 100 of a line focus type makes it difficult to detect the minute defect portion D in the conventional technique.

FIG. 8A is a view illustrating an interaction between the defect portion D and the ultrasonic beam U in the inspection object E, the view illustrating a scene of receiving the ultrasonic beam U (hereinafter, called “direct wave U3”) that directly reaches, as viewed from the side. FIG. 8B is a view illustrating an interaction between the defect portion D and the ultrasonic beam U in the inspection object E, the view illustrating a scene of receiving the ultrasonic beam U (“direct wave U3”) that directly reaches, as viewed from above. The direct wave U3 will be described later. Here, a case where the size of the defect portion D is smaller than the width (length WL) in the long axis direction of the ultrasonic beam U will be considered. The length WL here is the width in the long axis direction of the ultrasonic beam U that converged. The size of the defect portion D is smaller than the width (length WS) in the short axis direction of the ultrasonic beam U. The defect portion D exists in the irradiation region of the ultrasonic beam U.

FIG. 8A schematically illustrates the shape of the ultrasonic beam U in a minute region in the vicinity of the defect portion D, and thus the ultrasonic beam U is drawn in parallel, but the ultrasonic beam U is actually converged. Furthermore, the position of the reception probe 121 in FIG. 8A is a conceptual position for easy understanding, and the position and shape of the reception probe 121 are not accurately scaled. That is, considering the enlarged scale of the shapes of the defect portion D and the ultrasonic beam U, the reception probe 121 is positioned at a position more distant in the up-down direction in the drawing than the position illustrated in FIG. 8A.

FIGS. 8A and 8B illustrate the case of the block method in which the transmission sound axis surface AX1 and the reception sound axis AX2 coincide with each other. When the size of the defect portion D is smaller than the length WL, some ultrasonic beams U are blocked, and therefore the reception signal decreases but does not become zero. For example, in a case where the length WL is 20 mm and the diameter of the defect portion D is 1 mm, since the beam amount blocked by the defect portion D is equal to or less than 5%, the reception signal decreases only by approximately equal to or less than 5%, and thus it is difficult to detect the defect portion D. As described above, when the defect portion D is smaller than the length WL, the number of ultrasonic beams U passing without interacting with the defect portion D increases, and therefore the detection accuracy of the defect portion D decreases. This is the reason why use of the transmission probe 110 of a line focus type makes it difficult to detect the minute defect portion D.

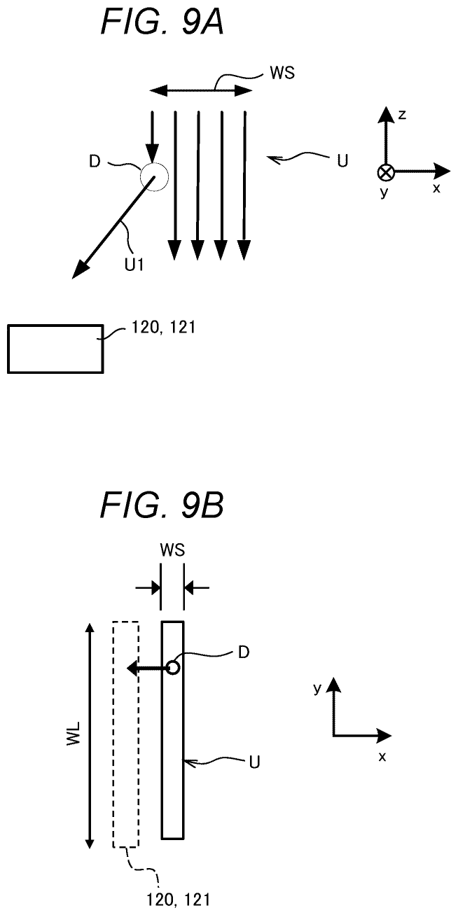

FIG. 9A is a view schematically illustrating a scattering wave U1 that is the ultrasonic beam U interacting with the defect portion D, the view of the scattering wave as viewed from the side. FIG. 9B is a view schematically illustrating the scattering wave U1 that is the ultrasonic beam U interacting with defect portion D, the view of the scattering wave U1 as viewed from above. The defect portion D exists in the irradiation region of the ultrasonic beam U.

In the present disclosure, the ultrasonic beam U interacting with the defect portion D is called the scattering wave U1. Therefore, the “scattering wave U1” in the present disclosure refers to an ultrasonic wave interacting with the defect portion D. The scattering wave U1 includes a wave that changes its direction as illustrated in FIG. 9B. The scattering wave U1 includes a wave in which at least one of the phase and the frequency of the wave changes due to an interaction with the defect portion D but the traveling direction does not change. An ultrasonic wave passing without interacting with the defect portion D is called the direct wave U3. If only the scattering wave U1 can be detected distinguishably from direct wave U3, a small defect portion D can be easily detected. In the present disclosure, the scattering wave U1 is efficiently detected by focusing on the difference in frequency.

In the present example, the scattering wave U1 is detected by extracting a signal component in a specific frequency domain of a reception waveform. In this configuration, by appropriately selecting the frequency to be detected, the component of the direct wave U3 to be extracted from the reception signal can be reduced, and the component of the scattering wave U1 can be increased. Therefore, as illustrated in FIGS. 9A and 9B, even using a line convergence beam using the transmission probe 110, the contribution of the direct wave U3 component to be extracted can be kept small. On the other hand, since the scattering wave U1 from the defect portion D is extracted from the signal, the defect portion D can be detected. In this way, in the present example, the minute defect portion D can also be detected.

As described above, in the present embodiment, the gas G such as air is used as the fluid F between the transmission probe 110 and the inspection object E. In this case, it is particularly difficult to detect the minute defect portion D by the conventional block method for the reason described below. Therefore, the effect of the present disclosure of detecting the scattering wave U1 is large.

An attenuation amount of the ultrasonic wave is larger in the gas G than that in the liquid W. It is known that the attenuation amount of the ultrasonic wave in the gas G is proportional to the square of the frequency. Therefore, about 1 MHz is the upper limit of propagation of the ultrasonic wave in the gas G. In the case of the liquid W, the ultrasonic waves of 5 MHz to several 10 MHz also propagate, and therefore the usable frequency in the gas G is smaller than that in the liquid W.

In general, when the frequency of the ultrasonic beam U decreases, convergence of the ultrasonic beam U becomes difficult. Therefore, the ultrasonic beam U of 1 MHz propagating in the gas G has a larger convergeable beam diameter than that of the ultrasonic beam U in the liquid W. On the other hand, as illustrated in FIGS. 8A and 8B, it is difficult to detect the defect portion D smaller than the beam size in a block mode that is a conventional method. However, according to the present disclosure, as illustrated in FIG. 5, since the proportion of the components of the scattering wave U1 is increased and detected, it is possible to detect the defect portion D smaller than the beam size.

### (Configuration of Control Device)

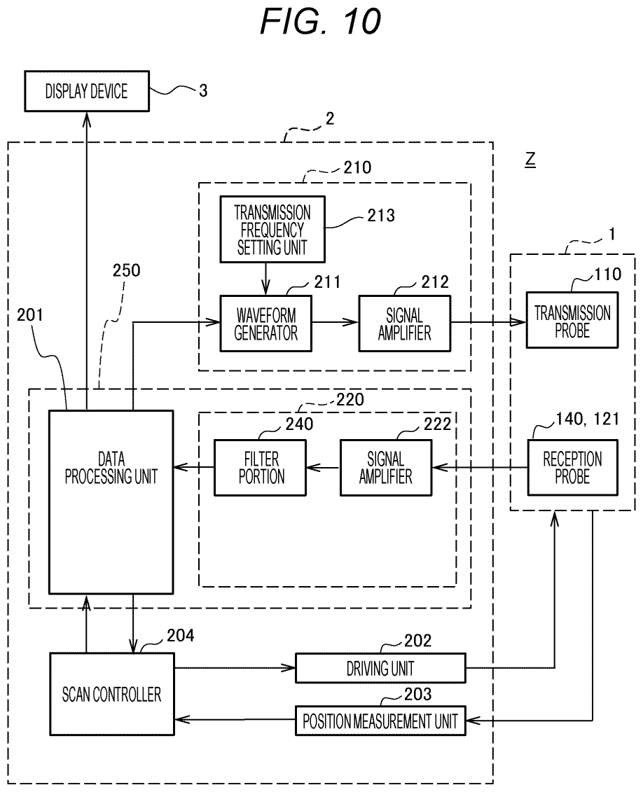

FIG. 10 is a functional block diagram of the control device 2. The control device 2 controls drive of the scanning measurement device 1. The control device 2 includes a transmission system 210, a reception system 220, a data processing unit 201, a scan controller 204, a driving unit 202, a position measurement unit 203, and a signal processing unit 250. By driving the transmission probe 110 and the reception probe 121, for example, the driving unit 202 changes the relative positions of the transmission probe 110 and the reception probe 121 with respect to the inspection object E. The position measurement unit 203 measures a scanning position. The scan controller 204 drives the transmission probe 110 and the reception probe 121 through the driving unit 202. The scanning positions of the transmission probe 110 and the reception probe 121 are input to the scan controller 204 through the position measurement unit 203.

The reception system 220 and the data processing unit 201 are collectively called the signal processing unit 250. That is, the signal processing unit 250 includes the reception system 220 and the data processing unit 201, and performs signal processing of extracting significant information by amplifying, filtering, or the like on the signal from the reception probe 121.

### (Natural Frequency Fres and Excitation Frequency Fex of Transmission Probe 110)

The transmission system 210 is a system that generates a voltage applied to the transmission probe 110. The transmission system 210 includes a waveform generator 211, a signal amplifier 212, and a transmission frequency setting unit 213. A burst wave signal is generated in the waveform generator 211. Then, the generated burst wave signal is amplified by the signal amplifier 212. The voltage output from the signal amplifier 212 is applied to the transmission probe 110. Therefore, the transmission probe 110 is driven by the burst wave.

Although the waveform of the burst wave signal will be described later, the waveform is a waveform of a periodic wave packet in which the wave packet having the wavenumber N0 is repeated at a fundamental frequency f0 in the first embodiment. That is, the transmission system 210 of the control device 2 drives the transmission probe 110 so as to emit the ultrasonic beam U by applying a voltage waveform of a periodic wave packet including a wave packet having the wavenumber N0 of equal to or greater than 2. Together with this, the transmission system 210 of the control device 2 drives the transmission probe 110 at the excitation frequency fex higher than the natural frequency fres of the transmission probe 110.

The transmission system 210 includes the transmission frequency setting unit 213. The fundamental frequency f0 can be changed by the transmission frequency setting unit 213, and the fundamental frequency f0 can be set to an appropriate excitation frequency fex. One of the features of the present disclosure is a selection method of the fundamental frequency f0, and thus the fundamental frequency f0 after the change is called the excitation frequency fex based on the meaning of the frequency at which the transmission probe 110 is excited.

As described later, by setting the excitation frequency fex to an appropriate value, the performance of the ultrasonic inspection device Z of the present embodiment can be improved.

In general, when the transmission probe 110 is operated at a specific frequency determined for each probe, the amplitude intensity (sound pressure) of the generated ultrasonic wave becomes maximum. This maximum frequency will be called the natural frequency fres of the transmission probe 110. The reason for the sound pressure to be maximized at the natural frequency fres is that the oscillation of the built-in piezoelectric element resonates at the natural frequency fres. That is, in the present description, the natural frequency fres is synonymous with the resonance frequency. Therefore, normally, the excitation frequency fex is set equal to the natural frequency fres, and the transmission probe 100 is used.

In the present embodiment, the excitation frequency fex is set to a frequency shifted upward from the natural frequency fres of the transmission probe 110. Therefore, the scanning measurement device 1 drives the transmission probe 110 at the excitation frequency fex shifted from the natural frequency fres (synonymous with the resonance frequency) of the transmission probe 110. That is, the transmission frequency setting unit 213 sets the excitation frequency fex to a frequency higher than the natural frequency fres of the transmission probe 110. Due to this, the transmission probe 110 is driven at the excitation frequency fex higher than the natural frequency fres of the transmission probe 100. By setting the excitation frequency fex to an appropriate value, the performance of the ultrasonic inspection device Z can be enhanced. The significance of shifting high will be described.

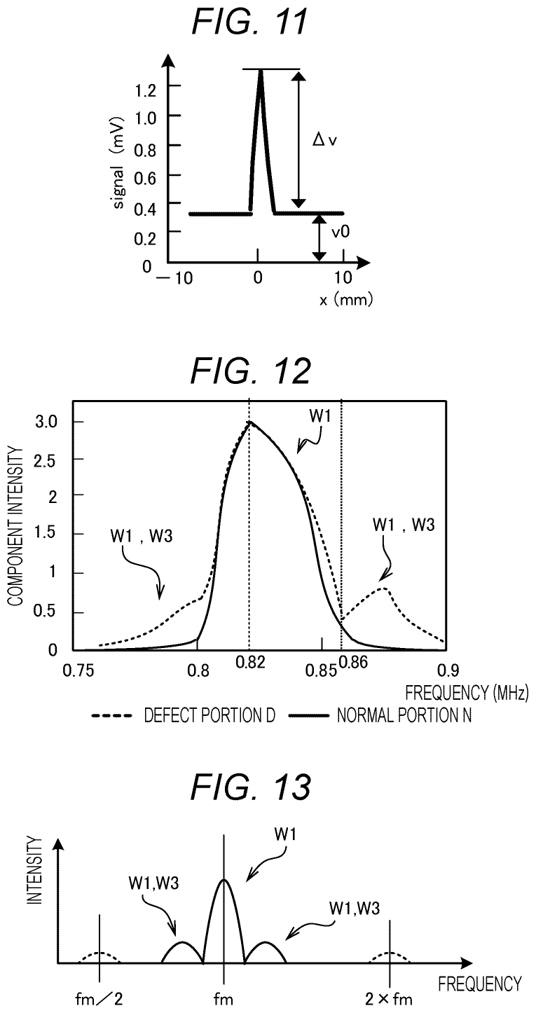

FIG. 11 is a view illustrating the signal intensity when the transmission probe 110 and the reception probe 121 are scanned across the defect portion D in the inspection object E. Inside the inspection object E, there is the defect portion D having a width of 1 mm at a position of x=0.

FIG. 11 illustrates a result of setting the excitation frequency fex to 0.86 MHz. 0.86 MHz is a frequency higher by 40 kHz than the natural frequency fres=0.82 MHz of the transmission probe 110. Of the signal detected by the reception probe 121, a range of 0.86 to 0.90 MHz is extracted by a filter unit 240 (FIG. 10). The extracted range does not include a maximum component frequency fm=0.82 MHz and is a frequency higher than fm. The detected frequency component is a skirt component W3 (described later) of the fundamental waveband W1.

As described above, under this measurement condition, since the direct wave U3 component is reduced, the signal is small in the normal portion N, and the scattering wave U1 component occurs in the defect portion D, and therefore the signal is large. Therefore, even the minute defect portion D can be detected.

FIG. 12 is a view illustrating an example of a spectrum of a reception signal observed in the present embodiment. The solid line is a spectrum at the normal portion N, and the broken line is a spectrum at a position including the defect portion D of the inspection object E.

The spectrum of the normal portion N indicated by the solid line is a spectrum in which the fundamental waveband W1 has a peak at the natural frequency fres=0.82 MHz. That is, in the example of FIG. 12, 0.82 MHz is the maximum component frequency fm. This is a spectrum based on the direct wave U3.

On the other hand, the spectrum at the position including the defect portion D indicated by the broken line is larger than the spectrum at the normal portion N particularly at 0.86 to 0.9 MHz of the skirt component W3 of the fundamental waveband W1. In this, a component due to the scattering wave U1 at the defect portion D appears. Therefore, when the frequency range of 0.86 to 0.9 MHz is detected, the signal feature increases corresponding to the defect portion D as in FIG. 11.

When the spectrum of the broken line in FIG. 12 is viewed, the skirt component W3 on the lower frequency side than the maximum component frequency fm is larger than the solid line (spectrum of the normal portion N) also at 0.75 to 0.8 MHz. Therefore, the signal feature may be obtained by extracting a frequency component on a lower frequency side than the maximum component frequency fm of the skirt component W3 of the fundamental waveband W1.

Both the skirt component W3 on a radio frequency side and the skirt component W3 on a low frequency side may be detected from the maximum component frequency fm. A bandstop filter (described later) may be used for this. In the spectrum (spectrum at the position including the defect portion D) indicated by the broken line in FIG. 12, when the skirt component W3 on the low frequency side and the skirt component W3 on the radio frequency side are compared with each other, the frequency component is larger on the radio frequency side. Therefore, it is more preferable to detect the skirt component W3 having a frequency higher than the maximum component frequency fm.

In the present embodiment, a line focus type is used as the transmission probe 110, and a reception probe of non-convergence type is used as the reception probe 121. Since the focal length of the reception probe 121 of a non-convergence type is infinite, the focal length of the reception probe 121 is longer than the focal length of the transmission probe 110. Such a configuration is preferable because the scattering wave U1 scattered at a small angle at the defect portion D can also be received, and thus information regarding the defect portion D increases.

Here, meanings of the fundamental waveband W1 and the skirt component W3 in the present disclosure will be described.

FIG. 13 is a view schematically illustrating the distribution (frequency spectrum) of frequency components of a reception signal. In FIG. 13, the horizontal axis represents frequency, and the vertical axis represents component intensity (intensity). The vertical axis represents a logarithmic scale and schematically indicates a wide intensity range.

The maximum component frequency at which the component intensity is maximized is fm. The maximum component frequency fm is approximately equal to the fundamental frequency f0 of the burst wave transmitted from the transmission probe 110. The frequency component of the signal spreads before and after the maximum component frequency fm, which is called the fundamental waveband W1.

A component having a frequency (N×fm), which is N times the maximum component frequency fm, is a harmonic. A component having a frequency (fm/N), which is 1/N times the maximum component frequency fm, is a subharmonic. Here, N is an integer of N≥2. The harmonic and the subharmonic each spread. In the present disclosure, in a case of particularly emphasizing that the harmonic and the subharmonic have a frequency spread, the harmonic and the subharmonic are called a harmonic band and a subharmonic band, respectively. Therefore, when “harmonic” is simply mentioned, it also has a frequency spread. The harmonic band and the subharmonic band are generated by a nonlinear phenomenon, and are generated when the sound pressure of the ultrasonic beam U input to the inspection object E is extremely strong.

As in the first embodiment, when the gas G is interposed between the transmission probe 110 and the inspection object E, it is generally difficult to bring the ultrasonic beam U having a high sound pressure into the inspection object E, and thus at least one of the harmonic band and the subharmonic band is often not observed. Even under the condition in the first embodiment, the harmonic band and the subharmonic band are equal to or less than a detection limit.

As illustrated in FIG. 13, the fundamental waveband W1 has a frequency spread. In the fundamental waveband W1, a frequency component other than the component of the maximum component frequency fm will be called the “skirt component W3”. The skirt component W3 also includes a side lobe of the fundamental wave.

Returning to FIG. 12, the spectrum illustrated in FIG. 12 is a spectrum of the fundamental waveband W1. This can be seen from the frequency range in FIG. 12. The frequency range in FIG. 12 is 0.75 to 0.9 MHz, which is a narrow range of ±10% of the natural frequency f0=0.82 MHz of the transmission probe.

Referring to FIG. 12, in the frequency range of 0.86 to 0.9 MHz, the frequency component is substantially zero in the normal portion N (solid line), whereas there is a frequency component in the defect portion D (dotted line). Therefore, when a frequency component of 0.86 to 0.9 MHz is detected, the signal illustrated in FIG. 11 is obtained. By appropriately selecting the frequency range to be detected in this manner, it is possible to reduce the direct wave U3 component and extract the scattering wave U1 component. This can detect the minute defect portion D also using the transmission probe 110.

As illustrated in FIG. 12, in the present embodiment, the skirt component W3 increases. One of the reasons for the skirt component W3 to increase is that the focal length of the reception probe 121 is made longer than the focal length of the transmission probe 110, and therefore more scattering wave U1 components scattered at the defect portion D are received.

Referring back to FIG. 10, the signal processing unit 250 includes the data processing unit 201 and the reception system 220. The reception system 220 is a system that detects a reception signal output from the reception probe 121. The reception system 220 includes a signal amplifier 222 and the filter unit 240. Therefore, the control device 2 includes the signal processing unit 250, and the signal processing unit 250 includes the filter unit 240. The signal output from the reception probe 121 is input to the signal amplifier 222 and amplified. The signal amplified by the signal amplifier 222 (the output signal from the signal amplifier 222) is input to the filter unit 240 (cutoff filter). The filter unit 240 reduces (blocks) components in a specific frequency range of the input signal. The filter unit 240 will be described later. The output signal from the filter unit 240 is input to the data processing unit 201.

The data processing unit 201 generates signal intensity data from the signal input from the filter unit 240. In the present embodiment, a peak-to-peak signal is used as a generation method of the signal intensity data. The peak-to-peak signal is a difference between the maximum value and the minimum value of the signal. As a generation method of the signal intensity data, Fourier transform may be performed, and the intensity of the frequency component in the specific frequency range may be used.

The data processing unit 201 also receives information on the scanning position from the scan controller 204. In this way, the value of the signal intensity data at a current two-dimensional scanning position (x, y) is obtained. When the value (peak-to-peak signal) of the signal intensity data is plotted with respect to the scanning position, an image (defect image) corresponding to at least one of the position and the shape of the defect portion D is obtained. This defect image is output to the display device 3.

### (Filter Unit 240)

In the present disclosure, the filter unit 240 is defined as a control unit that performs signal processing for reducing the intensity of signal components in a predetermined frequency range. The filtering is defined as signal processing for reducing the intensity of signal components in a predetermined frequency range. When the reception signal is decomposed into component intensity of each frequency component by Fourier transform or the like, a frequency at which the component intensity is maximized is called a maximum component frequency. The maximum intensity frequency component is a frequency component at the maximum component frequency fm. The filter unit 240 of the present disclosure reduces the intensity of the signal component of the fundamental waveband W1 including the maximum intensity frequency component, that is, a frequency range W2 including the maximum component frequency fm. Note that the distribution of the component intensity for each frequency component is called a frequency spectrum.

In the first embodiment, the filter unit 240 reduces the component intensity in a cutoff frequency range including the maximum component frequency fm. That is, the filter unit 240 reduces at least the maximum intensity frequency component (component corresponding to the maximum component frequency fm) of the reception signal of the reception probe 121. Then, the filter unit 240 detects the skirt component W3 other than the maximum intensity frequency component in the fundamental waveband W1 including the maximum intensity frequency component. Since the component intensity in the cutoff frequency range is reduced by the filter unit 240, the proportion of the skirt component W3 in the fundamental waveband W1 increases in the signal after passing through the filter unit 240. In this way, the detection performance of the defect portion D (in particular, detection accuracy of the shape of the defect portion D) can be improved.

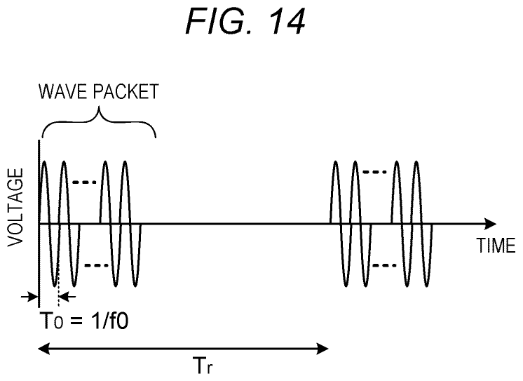

FIG. 14 is a voltage waveform of a burst wave applied to the transmission probe 110. The horizontal axis represents time, and the vertical axis represents voltage. In the example of FIG. 14, ten sine waves having the fundamental frequency f0 of 0.86 MHz are applied. These ten waves are called a wave packet. Note that the reciprocal of the fundamental frequency f0 is called a fundamental period TO. As illustrated in the drawing, the fundamental period TO is a period of a wave constituting one wave packet. The wave packet is applied with a repetition period Tr=5 ms. Therefore, the transmission probe 110 emits the ultrasonic beam U by being applied with a voltage waveform of a periodic wave packet including a wave packet having the wavenumber N0 of equal to or greater than 2.

Note that in the present embodiment, a sine wave having the fundamental frequency f0 is used as each wave packet, but a wave other than the sine wave may be used. For example, the wave packet may be a wave packet constituted by a rectangular wave having a wavenumber N.

The wavenumber N0 of the wave packet is the number of waves (the number of cycles) having the fundamental frequency f0 included in one wave packet. In the present disclosure, the wavenumber N0 of the wave packet is equal to or greater than 2, and the wavenumber N0 of the wave packet is preferably 3 or more. Under the experimental conditions of the present embodiment, the wavenumber N0 is ten waves as described above. A waveform of a periodic wave packet that repeats a wave packet is called a burst wave.

As illustrated in FIG. 12, the present disclosure is based on a new finding found by the inventors that a signal change rate at the defect portion D is larger in the skirt component W3 of the fundamental waveband W1 than in the signal component at the maximum component frequency fm in the frequency component distribution of the reception signal. Furthermore, the present invention is based on a new finding found by the inventors that there is a frequency domain in which the signal intensity is larger in the defect portion D than in the normal portion N also within the range of the fundamental waveband W1. By setting an appropriate detection frequency range based on this finding, the detectability of the defect portion D is improved.

In particular, in the present embodiment, a frequency component having a small direct wave U3 component is selected. In this way, since the direct wave U3 component is reduced, it is possible to detect the minute defect portion D even using the transmission probe 110.

### (Effects of Burst Wave)

In the present disclosure, an effect of applying a voltage waveform of a burst wave, that is, a periodic wave packet, to the transmission probe 110 will be described.

As described above, the present disclosure is based on the new finding that the signal change rate in the defect portion D is large in the frequency component (skirt component W3) shifted by Δf from the maximum component frequency fm. Therefore, by narrowing the band of the fundamental waveband W1 to an appropriate width, the frequency domain of the shifted component (fm±Δf) falls within a specific region, and therefore the defect information included in the shifted component (skirt component W3) can be easily detected.

On the other hand, when a voltage waveform of a single pulse or one period is applied, the frequency band of the transmission wave expands over a wide band as described later, and thus the shifted component (fm±Δf) also expands over a wide frequency range. Therefore, it is difficult to extract and detect a frequency component shifted by Δf as in the present disclosure. Note that a voltage waveform having a single pulse or a wavenumber of 1 is generally not included in a burst wave. Also in the present description, the burst wave is defined as one having a wavenumber N constituting a wave packet of equal to or greater than 2.

In order to clarify a difference between the present disclosure using a burst wave and a conventional example using a single pulse, a conventional example of applying a single pulse will be described below.

A method of applying a voltage waveform of a single pulse or one period to inspect the defect portion D inside the inspection object E is known as a pulse echo method. By measuring the time from transmission to reception of the ultrasonic beam U, the distance to the defect portion D can be known.

In the pulse echo method, the time from transmission to reception of the ultrasonic beam U is accurately measured. For this reason, the waveform of the ultrasonic beam U can be more accurately measured as the time is shorter. Therefore, time is measured by applying one pulse. That is, the wavenumber N0 is 1 or ½. In order to obtain a short waveform in the time domain, the frequency domain is set to a wide band (e.g., range between 0 and twice the maximum component frequency fm. 0 to 2×fm). Therefore, in the pulse echo method, a wideband transmission probe and a reception probe are usually used.

In the pulse echo method, which is a conventional method, a frequency band is set to a wide band as described above in order to obtain a short waveform in a time domain. On the other hand, in the present disclosure, since a specific frequency domain is detected in the frequency domain, the frequency band is preferably narrowed within an appropriate range, and thus the burst wave is used. An appropriate frequency band in the present disclosure will be described later.

Next, the relationship between the wavenumber N0 of the wave packet applied to the transmission probe 110 and the frequency band of the transmitted ultrasonic wave will be described.

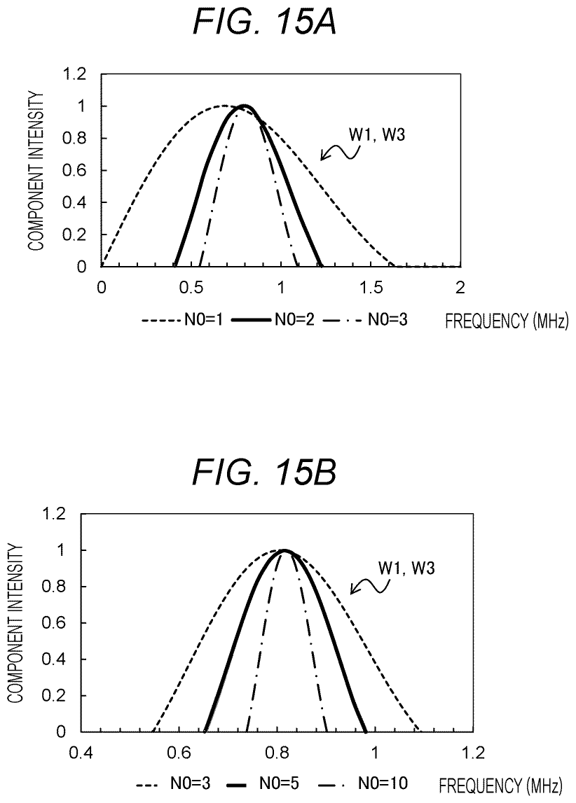

FIG. 15A illustrates a frequency spectrum of the transmission ultrasonic wave when the wavenumber N0 is varied. Here, the frequency spectrum was calculated by performing Fourier transform on the time waveform of the wave packet constituted by the wavenumber N0. The fundamental frequency f0 of the wave constituting the wave packet N0 is 0.82 MHz. FIG. 15A illustrates a spectrum in a case where the number of wavenumbers N0 is 1 to 3. Note that in the case of one wavenumber, the wave packet is not formed, and thus no periodic wave packet is formed and is not a burst wave.

When the wavenumber N0=1 indicated by the broken line, it is indicated that the frequency component of the fundamental waveband W1 expands in the frequency range of 0 to 1.6 MHz. This corresponds to 0 to 2×fm. Therefore, as described above, it is difficult to preferentially extract a signal component shifted from the maximum component frequency fm as in the present disclosure. Note that the frequency spectrum with the wavenumber N0=1 is a typical spectrum shape of the pulse echo method.

As seen from FIG. 15A, when the wavenumber N0 indicated by the solid line is 2, the width (band) of the fundamental waveband W1 narrows to ½ of the case of N0=1. Furthermore, when the number of wavenumbers N0 indicated by the dash-dot line is 3, the width (band) of the fundamental waveband W1 narrows to ⅓ of the case of N0=1. Therefore, it is possible to extract a signal component shifted from the maximum component frequency fm as in the present disclosure.

FIG. 15B is a frequency spectrum in a case where the number of wavenumbers N0 is 3 (broken line), 5 (solid line), and 10 (dash-dot line). It should be noted that FIG. 15B illustrates a narrow frequency range of 0.4 to 1.2 MHz unlike FIG. 15A. It is indicated that when the wavenumber N0 is increased, the width (band) of the fundamental waveband W1 is further narrowed.

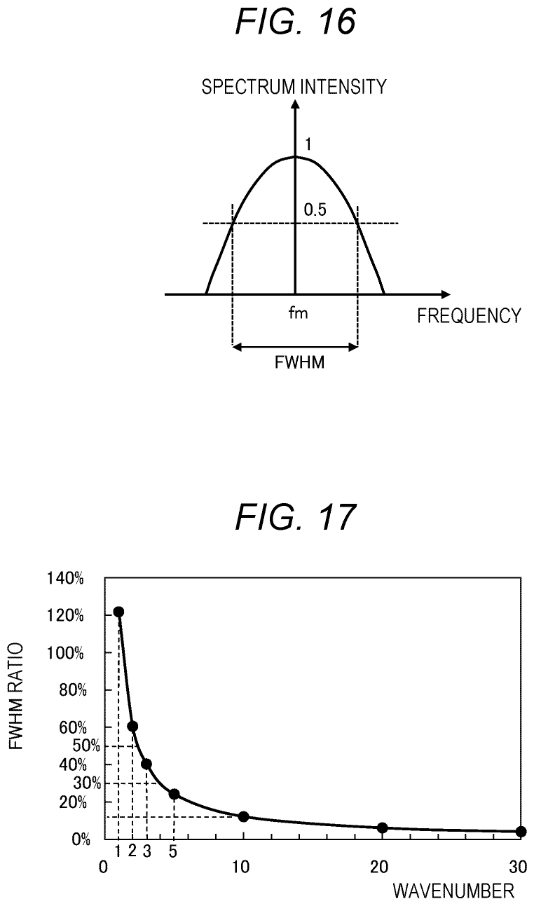

FIG. 16 is a view schematically illustrating the frequency spectrum of the fundamental waveband W1. The horizontal axis represents frequency, and the vertical axis represents spectral intensity. Here, the bandwidth of the fundamental waveband W1 is defined as follows. Assuming that the spectral intensity at the maximum component frequency fm of the fundamental waveband W1 is 1, the frequency width at ½ of the spectral intensity is full-width of half maximum (FWHM). A value in which the full-width of half maximum is normalized with the maximum component frequency fm is defined as a full-width of half maximum ratio (FWHM ratio). That is, the full-width of half maximum ratio is expressed by the following formula.

Full-width of half maximum ratio=Full-width of half maximum/fm

FIG. 17 is a view illustrating the relationship between the full-width of half maximum ratio (FWHM ratio) of the fundamental waveband W1 and the wavenumber N0. The full-width of half maximum ratio indicated on the vertical axis was calculated from the frequency spectra in FIGS. 15A and 15B. When the wavenumber N0 indicated on the horizontal axis is 1, the full-width of half maximum ratio expands up to 120%. When the wavenumber N0=2, the full-width of half maximum ratio narrows down to 60%. As described above, when N0=1, the frequency spectrum of the transmission wave expands in the range of 0 to 2×fm. On the other hand, when the wavenumber N0 is set to equal to or greater than 2, the effect of the present disclosure is large.

Note that since the signal component including information on the defect portion D appears in a frequency range of fm±0.25 fm, it is more preferable that the width of the fundamental waveband W1 of the frequency spectrum of the transmission wave is narrower than this. That is, the full-width of half maximum of the frequency spectrum of the fundamental waveband W1 is preferably equal to or less than 50% of the maximum component frequency fm. That is, the FWHM ratio is preferably equal to or less than 50%. This can improve the detection accuracy of the defect portion D. Note that the maximum component frequency fm is a frequency corresponding to the maximum intensity frequency component.

The full-width of half maximum ratio (FWHM ratio) of the fundamental waveband W1 can be set to equal to or less than 50% by setting the wavenumber N0 of the wave packet to 3 or more as seen from FIG. 17. Therefore, as described above, it is more preferable to set the wavenumber N0 of the wave packet to 3 or more.

Detecting the skirt component W3 of the fundamental waveband W1 improves the defect detectability. Therefore, the frequency detected by the filter unit 240 (FIG. 10) preferably includes a frequency in the range of (fm±0.25 fm) with respect to the maximum component frequency fm. Here, “0.25 fm” means 0.25 times (i.e., 25%) the maximum component frequency fm. As an example, when fm=1 MHz, it refers to a range of (1±0.25) MHz, that is, a range of (0.75 to 1.25) MHz. This corresponds to setting the full-width of half maximum ratio to equal to or less than 50%.

As seen from FIG. 17, when the wavenumber N0 is 5 or more, the full-width of half maximum ratio of the fundamental waveband W1 is 30% or less. Correspondingly, the frequency detected by the filter unit 240 more preferably includes a frequency range of (fm±0.15 fm) with respect to the maximum component frequency fm.

### (Narrow Band Probe)

The transmission probe 110 includes a wide band probe and a narrow band probe. The full-width of half maximum ratio of the fundamental waveband W1 is about equal to or greater than 70% (e.g., equal to or greater than 70%) in the wide band probe, and the full-width of half maximum ratio is about equal to or less than 50% (e.g., equal to or less than 50%) in the narrow band probe.

In the pulse echo method, which is a conventional method, a wide band probe is often used in order to expand the frequency band of a transmission wave.

On the other hand, the narrow band probe is advantageous for detecting a frequency component of a specific frequency because energy of ultrasonic waves is concentrated in a narrow frequency range.

As described above, in the present disclosure, the full-width of half maximum ratio of the fundamental waveband W1 is preferably equal to or less than 50%. Also from this point, in the present disclosure, the transmission probe 110 is more preferably a narrow band probe.

### (Specific Example of Configuration of Filter Unit 240)

A representative example of the frequency characteristics of the filter unit 240 for achieving the effects of the present disclosure will be described below. The filter unit 240 preferably includes at least one of a bandstop filter, a low-pass filter, or a high-pass filter. By including at least one of these, components in a frequency range including the maximum component frequency fm can be reduced. In particular, by including at least one of the low-pass filter and the high-pass filter, only one of the high frequency and the low frequency is cut off, and therefore a program for cutting off can be simplified. When the filter unit 240 is implemented by an electronic circuit, a circuit configuration for cutting off can be simplified.

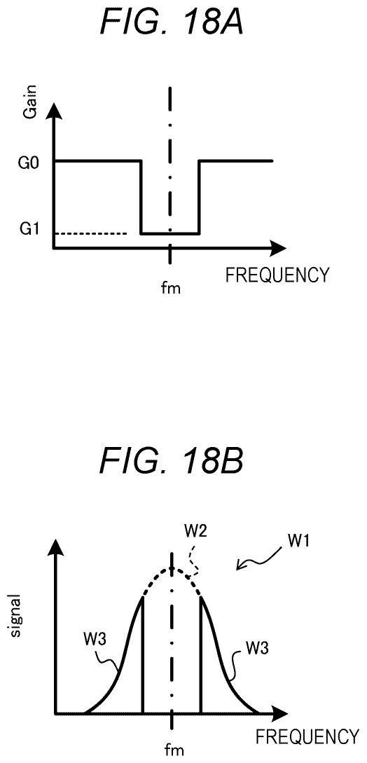

FIG. 18A illustrates frequency characteristics of a gain in the bandstop filter. The bandstop filter reduces components in the frequency range W2 (FIG. 18B) including the maximum component frequency fm in the fundamental waveband W1 (FIG. 18B) including the maximum component frequency fm (maximum intensity frequency component). A reduction rate x is a ratio G1/G0 of the gain G0 in a transmission region and the gain G1 in a cutoff region. In the first embodiment, the reduction rate x is −20 dB ( 1/10) to −40 dB ( 1/100).

FIG. 18B is a view schematically illustrating frequency characteristics of a signal after being processed by the bandstop filter. Waveforms indicated by the solid line and the dotted line are the fundamental waveband W1. The dotted line indicates a signal component before processed, and a component in the frequency range W2 indicated by a part of the dotted line is reduced by the bandstop filter. As a result, the skirt component W3 of the fundamental waveband W1 indicated by the solid line can be detected.

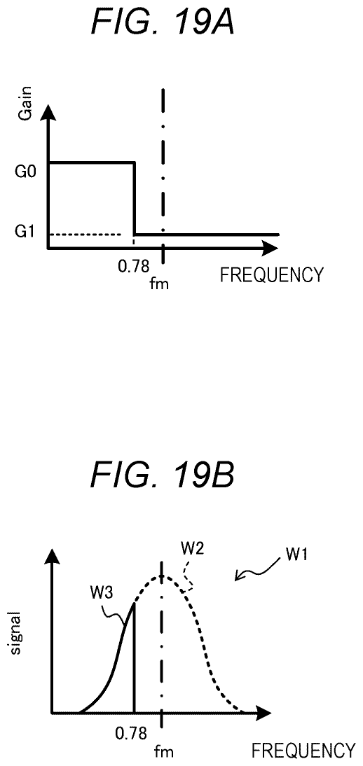

FIG. 19A illustrates frequency characteristics of a gain in the low-pass filter. By setting the cutoff frequency of the low-pass filter to a frequency smaller than the maximum component frequency fm, the signal component at the maximum component frequency fm can be reduced. Here, the cutoff frequency of the filter is a frequency at a boundary between a passband for allowing a signal to pass and an attenuation band for attenuating the signal. In the first embodiment, the cutoff frequency is 0.78 MHz. That is, the frequency was set to be lower by 40 kHz than the maximum component frequency fm. The reduction rate at a cutoff portion was set to about −40 dB.

FIG. 19B is a view schematically illustrating frequency characteristics of a signal after being processed by the low-pass filter. The meanings of the dotted line and the solid line are the same as those in FIG. 18B. When the low-pass filter is used, a frequency component smaller than the maximum component frequency fm in the skirt component W3 can be detected as indicated by the solid line.

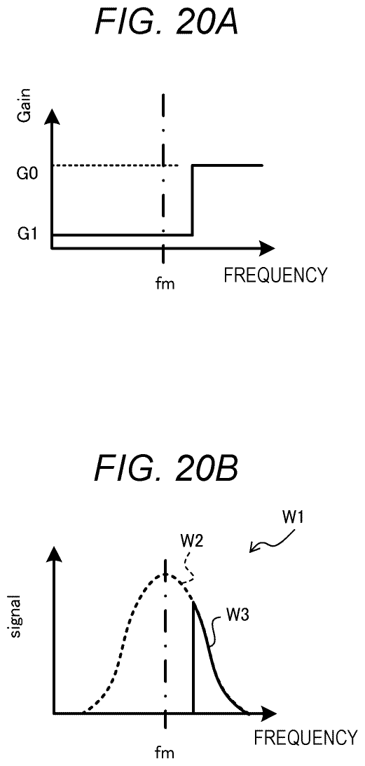

FIG. 20A illustrates frequency characteristics of a gain in the high-pass filter. By setting the cutoff frequency of the high-pass filter to a frequency larger than the maximum component frequency fm, the signal component at the maximum component frequency fm can be reduced.

FIG. 20B is a view schematically illustrating frequency characteristics of a signal after being processed by the high-pass filter. The meanings of the dotted line and the solid line are the same as those in FIG. 18B. When the high pass filter is used, a frequency component larger than the maximum component frequency fm can be detected in the skirt component W3 as indicated by the solid line.

### (Implementation Method of Filter Unit 240)

A typical configuration example of an implementation method of the filter unit 240 will be described below. The implementation method of the filter unit 240 is roughly divided into an analog method and a digital method.

The analog method reduces signal components in a desired frequency range by an analog circuit. Typical examples of frequency characteristics of the filter unit 240 include the bandstop filter (FIGS. 18A and 18B), the low-pass filter (FIGS. 19A and 19B), and the high-pass filter (FIGS. 20A and 20B). There are various known implementation methods of the analog circuit having such frequency characteristics. Therefore, the analog circuit may be implemented using an arbitrary implementation method.

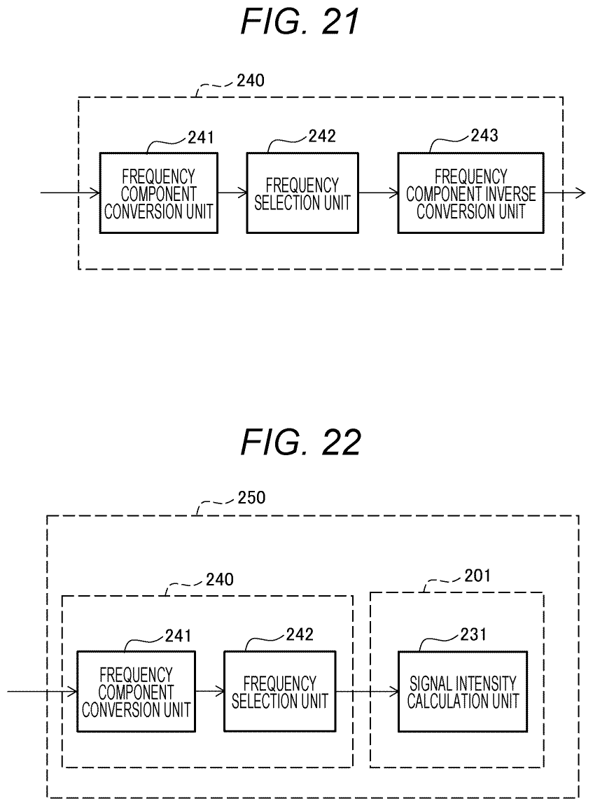

FIG. 21 is a block diagram illustrating the filter unit 240 of the digital method. The filter unit 240 includes a frequency component conversion unit 241, a frequency selection unit 242, and a frequency component inverse conversion unit 243. The frequency component conversion unit 241 converts, into a frequency component, a reception signal of the reception probe 121 input from the signal amplifier 222. The frequency selection unit 242 selects the skirt component W3 by removal of a frequency band including the maximum intensity frequency component (maximum component frequency fm). The frequency component inverse conversion unit 243 returns only necessary frequency components to a time domain signal. Among them, in particular, by including the frequency component conversion unit 241 and the frequency selection unit 242, the digital filter unit 240 can be configured.

Such the digital filter unit 240 can also reduce components in the frequency range including the maximum component frequency fm. The processing performed by the frequency component conversion unit 241 is processing of converting a signal waveform in the time domain into a frequency component, and typically uses Fourier transform. The processing performed by the frequency component inverse conversion unit 243 is processing of converting a frequency component (frequency spectrum) into a signal waveform in a time domain, and typically uses inverse Fourier transform.

FIG. 22 is a block diagram illustrating the filter unit 240 according to another embodiment. The filter unit 240 is provided in the signal processing unit 250. The filter unit 240 includes the frequency component conversion unit 241 and the frequency selection unit 242. The output of the frequency selection unit 242 is input to the signal intensity calculation unit 231 in the data processing unit 201. The signal intensity calculation unit 231 calculates the signal intensity based on information on the frequency component.

The reason for the skirt component W3 of the fundamental waveband W1 to change sensitively to the defect portion D is considered as follows.

In the direct wave U3 not interacting with the defect portion D, the propagation direction, the phase, the frequency, and the like of the wave do not change. Therefore, the proportion occupied by the direct wave U3 is large in the signal component of the maximum component frequency fm. Therefore, a change between the defect portion D and the normal portion N is small.

As illustrated in FIGS. 5A and 5B, the scattering wave U1 interacting with the defect portion D includes a component that changes the propagation direction and a component that does not change the propagation direction but changes at least one of the phase and the frequency. Among the components that change the propagation direction, there is a component whose frequency changes. Therefore, the proportion occupied by the component of the scattering wave U1, which is the ultrasonic beam U interacting with the defect portion D, increases in the skirt component W3 of the fundamental waveband W1, which is a component shifted from the maximum component frequency fm. Therefore, a change between the defect portion D and the normal portion N increases. In this way, by reducing the component of the maximum component frequency fm and detecting the skirt component W3 of the fundamental waveband W1, the detection performance of the defect portion D can be improved.

### (Skirt Component W3 of Fundamental Frequency)

As described above, the present disclosure improves the detection performance of the defect portion D by detecting the skirt component W3 of the fundamental waveband W1. Therefore, increasing the skirt component W3 of the fundamental waveband W1 further contributes to improvement of detection performance. Therefore, the inventors have intensively studied the relationship of the ultrasonic wave waveform to be transmitted in order to increase the skirt component W3 of the fundamental waveband W1.

The amount of the skirt component W3 of the fundamental waveband W1 is increased by the two effects of selections of the wavenumber and the excitation frequency of individual wave packets constituting the periodic wave packet.

### (Wavenumber of Wave Packet)

First, the relationship between the wavenumber of the wave packet constituting the periodic wave packet and the skirt component will be described. As illustrated in FIG. 14, the wavenumber of the wave packet is the number of waves of the fundamental frequency f0 included in one wave packet.

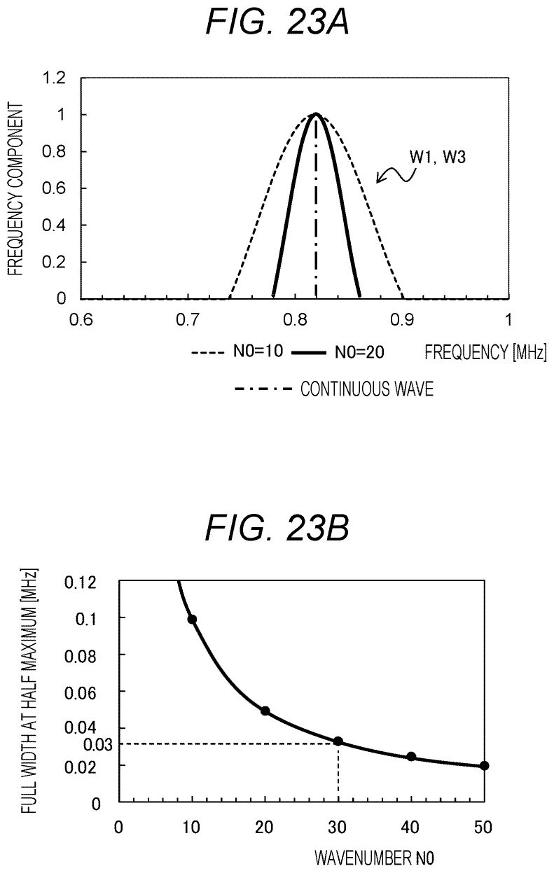

FIG. 23A is a frequency spectrum of the wavenumber N0 of the wave packet and the fundamental waveband W1 of the ultrasonic beam U thereof. Here, an ultrasonic wave having a fundamental frequency f0=0.82 MHz is taken as an example. Frequency spectra of wave packets of types of the wavenumbers N0=10 (broken line) and N0=20 (solid line) are shown. The spectrum indicated by the dash-dot line is a case of a continuous wave. In the case of the continuous wave, only the component of the fundamental frequency f0 exists, and the skirt component W3 hardly exists. On the other hand, as seen from the spectra at N0=20 and 10, as the wavenumber N0 decreases, the width of the fundamental waveband W1 expands, and the skirt component W3 increases.

FIG. 23B is a view illustrating how the full-width of half maximum (FWHM) of the fundamental waveband of the spectrum illustrated in FIG. 23A changes with respect to the wavenumber N0 of the wave packet.

According to the present disclosure, since the skirt component W3 of the fundamental waveband W1 has a large change due to the defect portion D, it is understood that the ultrasonic beam U used in the present disclosure is preferably not a continuous wave but the ultrasonic beam U including a periodic wave packet. Furthermore, as illustrated in FIG. 23B, since the skirt component W3 of the fundamental waveband W1 increases as the wavenumber N0 of each wave packet decreases, it is more preferable as the wavenumber N0 decreases. As illustrated in FIG. 23B, since the full-width of half maximum expands to equal to or greater than 30 kHz (0.03 MHz) at N0≤30, the wavenumber N0 of the wave packet is preferably 30 or less.

Note that it is not preferable that the full-width of half maximum (FWHM) of the fundamental waveband W1 is too wide, but is preferable that it is equal to or less than 50% of the maximum component frequency fm. In order to make the full-width of half maximum of the fundamental waveband W1 equal to or less than 50% of the maximum component frequency fm, the wavenumber N0 of the wave packet is preferably 2 or more, and the wavenumber N0 is more preferably 3 or more. These reasons are as described above with reference to FIG. 17.

As described above, the wavenumber N0 constituting the wave packet of the burst wave is preferably 2 or more and 30 or less. The wavenumber N0 is more preferably 3 or more and 30 or less.

### (Excitation Frequency Fex)

Next, the relationship between the excitation frequency fex and the skirt component W3 will be described. The excitation frequency fex is a frequency corresponding to the fundamental frequency f0 of the wave packet and is a frequency applied to the transmission probe 110.

In general, the transmission probe 110 has the natural frequency fres (resonance frequency). The natural frequency fres of the transmission probe 110 is a frequency at which the piezoelectric element constituting the transmission probe 110 is most likely to oscillate. Since application of a voltage of the natural frequency fres maximizes the intensity (acoustic energy) of the ultrasonic waves to be emitted, the excitation frequency fex is normally made equal to the natural frequency fres of the transmission probe 110.

On the other hand, in the present embodiment, the excitation frequency fex is set to a frequency shifted from the natural frequency fres. FIG. 12 illustrates a frequency spectrum when fex is set to 0.86 MHz, which is greater by 40 kHz than the natural frequency fres. Here, the excitation frequency fex is set to the frequency range of the fundamental waveband W1.

As seen from the spectrum (broken line) of the position including the defect portion D in FIG. 12, the amount (component intensity) of the skirt component W3 of the fundamental waveband W1 increases. Specifically, it has a component larger than that in the spectrum (solid line) of the normal portion N on a low frequency side (0.75 to 0.8 MHz) relative to the natural frequency fres=0.82 MHz. There is a frequency component having a peak near 0.87 MHz on a radio frequency side relative to the natural frequency fres. Here, both the component on the low frequency side and the component on the radio frequency side belong to the fundamental waveband W1. That is, it is the skirt component W3 of the fundamental waveband W1.

As seen by comparing the spectrum (solid line) of the normal portion N and the spectrum (dotted line) of the defect portion D illustrated in FIG. 12, the difference in the amount (component intensity) of the skirt component W3 of the fundamental waveband W1 is significant between the normal portion N and the defect portion D. Therefore, the detectability of the defect portion D is improved.

Referring to FIG. 12, in the skirt component W3 higher than the natural frequency fres or the skirt component W3 lower than the natural frequency fres, the component intensity increases at the defect portion D. Therefore, even when the transmission probe 110 is used, it is possible to detect the minute defect portion D.

The skirt component W3 higher than the natural frequency fres is more preferable because the increase in component intensity is larger.

As described above, by setting the excitation frequency fex to a value falling within the frequency range of the fundamental waveband W1 and shifted from the natural frequency fres, the amount of the skirt component W3 of the fundamental waveband W1 increases, and the detection performance of the defect portion D is improved. Therefore, the excitation frequency fex is preferably set in the frequency range of the fundamental waveband W1.

As described above, the full-width of half maximum of the fundamental waveband W1 is preferably equal to or less than 50% of the maximum component frequency fm. Therefore, the excitation frequency fex is preferably set in the range of (fres±0.25 fm). Here, fres is the natural frequency of the transmission probe. That is, the absolute value |fex−fres| of the difference between the excitation frequency fex and the natural frequency fres is preferably equal to or less than 25% of the maximum component frequency fm. Note that in the present disclosure, the natural frequency fres is synonymous with the resonance frequency.

When the transmission probe 110 is driven at the natural frequency fres, the strongest ultrasonic beam U is emitted. The emission efficiency of the ultrasonic beam U decreases as the shift of the excitation frequency fex from the natural frequency fres increases. Therefore, the absolute value |fex−fres| of the difference between the excitation frequency fex and the natural frequency fres is more preferably equal to or less than 15% of the maximum component frequency fm.

### (Range of Natural Frequency of Transmission Probe 110)

A preferable range of the natural frequency fres of the transmission probe 110 used in the present disclosure will be described.

In the present disclosure, the inspection object E is irradiated with the local ultrasonic beam U, and the defect portion D at the position is detected. Therefore, the beam diameter of the local ultrasonic beam U is preferably as small as possible. Therefore, it is preferable to use a convergence probe as the transmission probe 110.

Since the ultrasonic beam U is a wave, it is known to be difficult to converge the ultrasonic beam U to a wavelength degree or less even if the ultrasonic beam U is converged using an acoustic lens or the like. This is because the effect of diffraction of the wave appears.

In the ultrasonic beam U having the frequency f0, a wavelength λ in a medium at a sound speed c is expressed by λ=c/f0. With acryl as an example of the inspection object E, since the sound speed c is 2730 (m/s), the wavelength λ of the ultrasonic beam U is λ=54 mm at the frequency f0=50 kHz. That is, the ultrasonic beam U having the frequency f0=50 kHz can converge only up to about 50 mm even if the convergence probe is used, and it is difficult to sufficiently converge the ultrasonic beam U.

In the case of the frequency f0=200 kHz, since the wavelength λ=14 mm, the ultrasonic beam U that converged can be achieved. Therefore, the natural frequency fres of the transmission probe 110 is preferably equal to or greater than 200 kHz. In the present embodiment, the natural frequency of the transmission probe 110 is 0.82 MHz (820 kHz).

Note that in the present disclosure, since the scattering wave U1 is detected, the defect portion D smaller than the beam diameter can be detected as illustrated in FIGS. 5A and 5B.

Note that in the present embodiment, a sine wave having the fundamental frequency f0 is used as each wave packet, but a wave other than the sine wave may be used. For example, the wave packet may be constituted by a rectangular wave having a wavenumber N0.

The excitation frequency fex may be a wave having a plurality of excitation frequencies fex in one wave packet N0. As such a wave, a chirp wave whose frequency changes with time is known. Even when a wave having a plurality of excitation frequencies fex is used, each excitation frequency fex is preferably set to the frequency range of the fundamental waveband W1.

### Second Embodiment

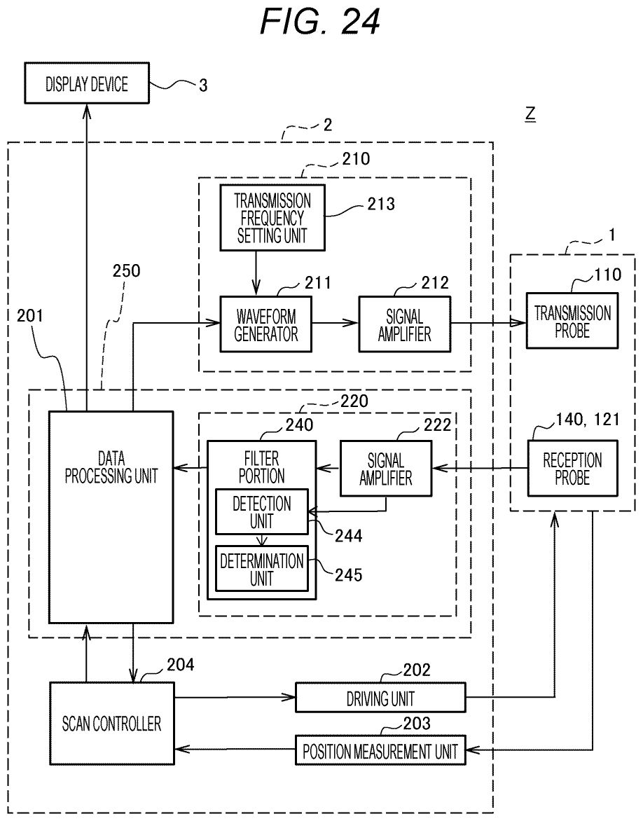

FIG. 24 is a functional block diagram of the control device 2 in the ultrasonic inspection device Z in the second embodiment. In the second embodiment, the type of the filter used in the filter unit 240 is determined by irradiating a sample (not illustrated) in which the position of the defect portion D is known with the ultrasonic beam U before inspection of the inspection object E. Then, the inspection of the inspection object E is performed using the filter determined before the inspection. In the present embodiment, similarly to the first embodiment, the transmission probe 110 is driven by a burst wave.

Similarly to the first embodiment, in the present embodiment, the excitation frequency fex is set to a frequency shifted from the natural frequency fres of the transmission probe 110. Therefore, the scanning measurement device 1 drives the transmission probe 110 at the excitation frequency fex shifted from the natural frequency fres (synonymous with the resonance frequency) of the transmission probe 110. By setting the excitation frequency fex to an appropriate value, the performance of the ultrasonic inspection device Z of the present embodiment can be improved.

The filter unit 240 includes a detection unit 244 and a determination unit 245. The detection unit 244 detects a plurality of different skirt components W3 in the fundamental waveband W1 in the relationship between the frequency and the signal intensity (component intensity). The relationship mentioned here is the relationship illustrated in FIG. 12 and the like, for example, and is obtained by irradiating, with the ultrasonic beam U, the normal portion N and the defect portion D in the sample (not illustrated) in which the position of the defect portion D is known. The determination unit 245 determines which skirt component W3 to use by comparison between the plurality of detected skirt components W3. By configuring the filter unit 240 in this manner, it is possible to use the skirt component W3 that makes it easy to identify a signal change caused by the defect portion D, and to improve the detection accuracy of the defect portion D.

The detection unit 244 includes a filter that can detect different skirt components W3, for example. The filter mentioned here is, for example, at least two of the bandstop filter (FIG. 18A), the low-pass filter (FIG. 19A), and the high-pass filter (FIG. 20A) described above. For example, in a case where the detection unit 244 includes these three filters, the detection unit 244 detects the skirt component W3 illustrated in FIG. 18B, the skirt component W3 illustrated in FIG. 19B, and the skirt component W3 illustrated in FIG. 20B using the three filters in the relationship illustrated in FIG. 12, for example. Then, by comparing the three detected skirt components W3, the determination unit 245 determines which skirt component W3 to use by selection of the skirt component W3 having the largest difference between the normal portion N and the defect portion D, for example. The filter unit 240 can improve the detection accuracy of the defect portion D by inspecting the inspection object E using the determined skirt component W3.

### Third Embodiment

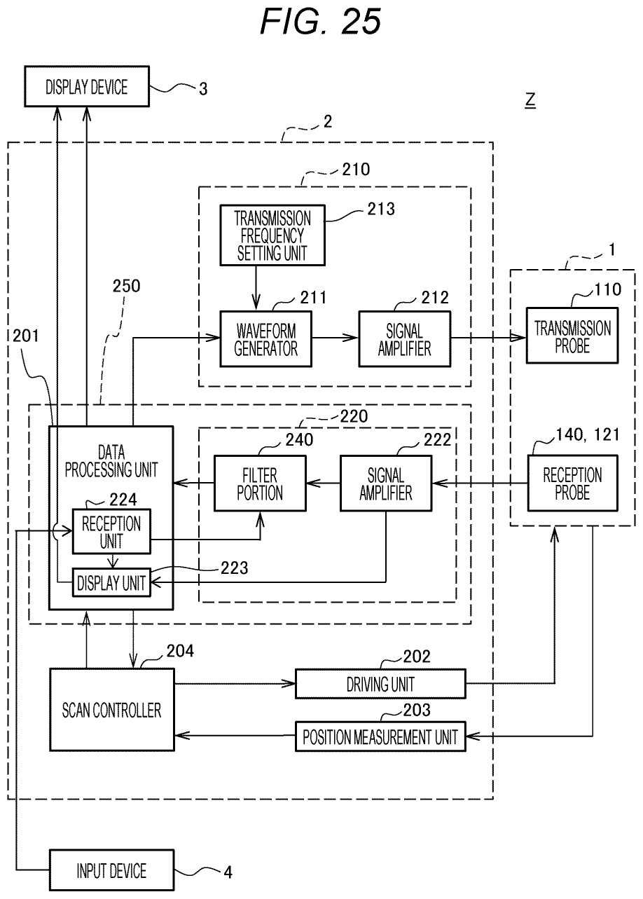

FIG. 25 is a functional block diagram of the control device 2 in the ultrasonic inspection device Z in the third embodiment. In the third embodiment, before inspection of the inspection object E, the data obtained by irradiating a sample (not illustrated) in which the position of the defect portion D is known with the ultrasonic beam U is presented to the user, and the user determines which skirt component W3 to use, that is, which filter to use.

Similarly to the first embodiment, in the present embodiment, the excitation frequency fex is set to a frequency shifted from the natural frequency fres of the transmission probe 110. Therefore, the scanning measurement device 1 drives the transmission probe 110 at the excitation frequency fex shifted from the natural frequency fres (synonymous with the resonance frequency) of the transmission probe 110. By setting the excitation frequency fex to an appropriate value, the performance of the ultrasonic inspection device Z of the present embodiment can be improved.

The control device 2 includes a display unit 223 and a reception unit 224. The display unit 223 and the reception unit 224 are included in the data processing unit 201 in the illustrated example. The display unit 223 displays, on the display device 3, the relationship between the frequency and the signal intensity (component intensity). The relationship mentioned here is the relationship illustrated in FIG. 12 and the like, for example, and is obtained by irradiating, with the ultrasonic beam U, the normal portion N and the defect portion D in the sample (not illustrated) in which the position of the defect portion D is known. The reception unit 224 receives information indicating the skirt component W3 to detect, which is input by the user based on the relationship between the frequency and the signal intensity. The input is performed through the input device 4 such as a keyboard, a mouse, or a touchscreen. Then, based on the information received by the reception unit 224, the filter unit 240 detects the skirt component W3 corresponding to the information.

By configuring the control device 2 in this manner, it is possible to judge the skirt component W3 to detect based on the subjectivity of the user. Accordingly, since the judgement can be made based on the experience of the user, inspection based on reality of the inspection entity can be executed.

### Fourth Embodiment

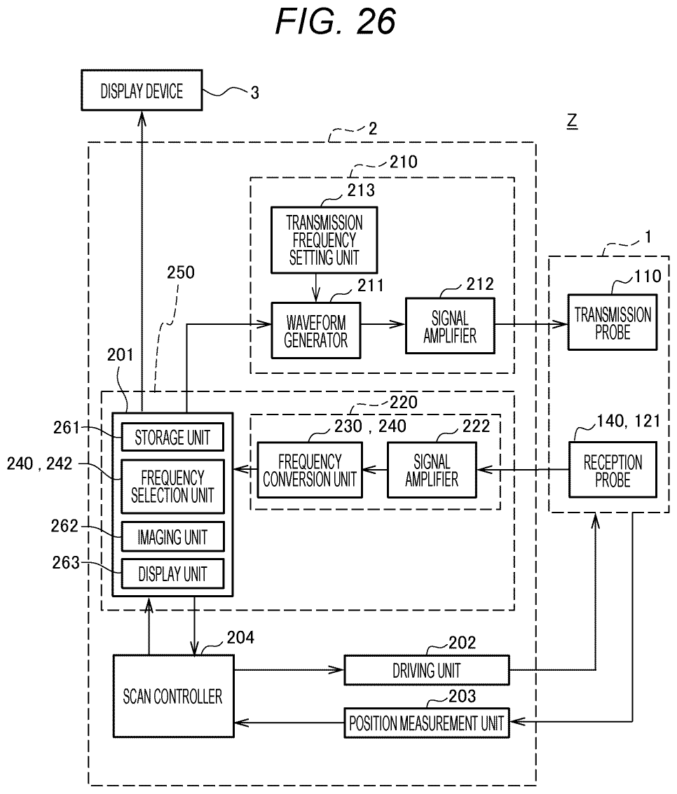

FIG. 26 is a functional block diagram of the control device 2 in the ultrasonic inspection device Z in the fourth embodiment. In the fourth embodiment, a reception signal is converted into a frequency component by a frequency conversion unit 230 and stored, and after measurement of inspection, imaging is performed using an appropriate frequency component. Thus, the filter unit 240 is configured. In the example of the present disclosure, the filter unit 240 includes the frequency conversion unit 230 and the frequency selection unit 242.

Similarly to the first embodiment, in the present embodiment, the excitation frequency fex is set to a frequency shifted from the natural frequency fres of the transmission probe 110. Therefore, the scanning measurement device 1 drives the transmission probe 110 at the excitation frequency fex shifted from the natural frequency fres (synonymous with the resonance frequency) of the transmission probe 110. By setting the excitation frequency fex to an appropriate value, the performance of the ultrasonic inspection device Z of the present embodiment can be improved.

The signal processing unit 250 performs signal processing of extracting significant information by amplifying the signal from the reception probe 121, frequency selection processing, or the like. The signal amplified by the signal amplifier 222 is input to the frequency conversion unit 230.

The frequency conversion unit 230 is included in the signal processing unit 250, and converts (signal processing) a reception signal of the reception probe 121 into a frequency component. In the example of the present disclosure, the frequency conversion unit 230 converts a reception signal that is a time domain waveform into a frequency component. The frequency component is a magnitude (spectrum) of each frequency component. Examples of the frequency component include a method of using a complex number to express the frequency component by a combination of a real part and an imaginary part, and a method of expressing the frequency component by an amplitude (absolute value) and a phase.

The conversion by the frequency conversion unit 230 can be executed by Fourier transform, for example. The conversion may be executed together with extraction of only frequency components in a frequency range (frequency parameter) designated in advance. The signal converted into the frequency component by the frequency conversion unit 230 is input to the data processing unit 201. Note that the frequency conversion unit 230 may be provided inside the data processing unit 201. That is, conversion into a frequency component may be performed in the data processing unit.

### (Accumulation of Frequency Component Data)

The data processing unit 201 includes a storage unit 261, the frequency selection unit 242, an imaging unit 262, and a display unit 263. Therefore, the signal processing unit 250 includes the frequency conversion unit 230, the imaging unit 262, the frequency selection unit 242, and the display unit 263.

In the example of the present disclosure, the frequency conversion unit 230 converts the time domain waveform into frequency component data, and saves the frequency component data in the storage unit 261 together with position information. Then, the imaging unit 262 generates an image 273 (described later) indicating the defect position using a part of the frequency component designated by a frequency parameter among converted frequency components, details of which will be described later. That is, the imaging unit 262 images a signal feature based on the input frequency parameter. That is, when the inspection object E is measured once, conversion into the frequency component data only needs to be performed once, and extraction of the signal feature from the frequency component data is performed a plurality of times.

This configuration is preferable in the following two points.

The first is a calculation required time. The conversion processing into frequency component data in the frequency conversion unit 230 takes time. Typically, Fourier transform is used as described above, but even if fast Fourier transform (FFT) known as a fast algorithm is used, the processing time of this transform is long. On the other hand, calculation of the signal feature is performed using Expression (1) described later, but this calculation required time is short. For a measurement point of 100 rows×100 columns as a typical example, the processing ends in equal to or less than 0.2 seconds.

Therefore, according to the example of the present disclosure, although details will be described later, when the frequency parameter is “updated”, an updated image 273 (described later) can be instantaneously obtained. As described above, by saving the frequency component data into the storage unit 261, it is possible to select, in a short time, a frequency set suitable for improving the detectability of the defect portion D.

Second, the data amount is reduced. While the signal waveform of the reception probe 140 has about 100,000 points in the time domain waveform for one measurement position, the frequency component data may have complex numbers for 20 to 100 types of frequencies. That is, the data amount with respect to the inspection object E can be reduced to about 1/1000. As described above, there is also an advantage that the data amount saved in the storage unit 261 can be significantly reduced.

The data processing unit 201 also receives information on the scanning position from the scan controller 204. In this way, data (hereinafter, called frequency component data) regarding the frequency component of the reception signal at the current two-dimensional scanning position (x, y) is obtained. The data processing unit 201 saves the scanning position (x, y) and the frequency component data at the position in the storage unit 261 in association with each other. Note that the image 273 regarding the defect portion D is created by determining, for each scanning position, the signal feature determined from the frequency component data.

The frequency component data is frequency components corresponding to a plurality of frequencies. In a typical example, the frequency component data is a frequency spectrum obtained by Fourier transform on the reception signal. As described above, the frequency component more preferably includes phase information in addition to the amplitude (absolute value). This is synonymous with treating frequency components as complex numbers. As described later, by including the phase information, it is possible to calculate a signal feature with higher performance.

In FIG. 26, the data processing unit 201 includes the imaging unit 262. The imaging unit 262 is included in the signal processing unit 250, and generates the image 273 (described later) indicating the position (defect position) of the defect portion D using a part of the frequency component designated by the frequency parameter among the converted frequency components. Specifically, the imaging unit 262 creates the image 273 based on the change (change amount) of the signal caused by the defect portion D of the inspection object E in the frequency spectrum of the part corresponding to an appropriate frequency parameter in the frequency spectrum corresponding to the frequency component converted by the frequency conversion unit 230. In this way, the image 273 can be generated.

In the example of the present disclosure, the change in the signal (change in the reception signal) is a signal feature. Therefore, the imaging unit 262 first calculates the signal feature from the part of the input frequency parameter of the frequency spectrum corresponding to the converted frequency component. Although the calculation method will be described later, the signal feature is, for example, a value representing a change of the signal as described above, and is a value calculated from the frequency component data so as to appropriately include defect information (e.g., the position of the defect portion D). An example of a specific calculation method of the signal feature will be described later. A two-dimensional image (defect image) of the defect portion D existing inside the inspection object E is generated by plotting the thus obtained signal feature with respect to the scanning position (x, y).

By performing the above procedure while varying the scanning position (x, y), a desired range is scanned. When the scanning is completed, the frequency component data and the signal feature corresponding to the scanning position (x, y) are saved in the storage unit 261 in the data processing unit 201. In the present disclosure, the signal feature is calculated every time a signal is acquired at a scanning position. However, the defect image may be generated by saving the frequency component data into the storage unit 261 during measurement and collectively calculating the signal features after the measurement.

### (Calculation of Signal Feature)

A calculation method of a signal feature from frequency component data used in the example of the present disclosure will be described.

Here, a frequency f is represented by an angular frequency ω in order to make the mathematical expression easy to see. The angular frequency ω is obtained by multiplying the frequency f by 2π. In addition, j represents an imaginary unit.

Processing of calculating a frequency component H(w) from a signal waveform h1(t) in the time domain actually measured will be described. This is an example of a method of processing an output signal of the signal amplifier 222 of FIG. 26 by the frequency conversion unit 230.

$$\begin{matrix}[ Expression 1 ] & \\ H ( ω ) = {\sum }_{k} {h}_{1} ( {t}_{k} ) exp ( - j ω {t}_{k} ) & Expression ( 1 )\end{matrix}$$

Here, tk is a time sequence arranged at a time interval of an appropriate sampling frequency. k is zero or a finite positive integer (k=0, 1, 2, . . . ). Expression (1) performs processing substantially equal to integration in a time range where the sum is obtained. The frequency component H(ω) is obtained by Expression (1).

An appropriate sampling frequency is a frequency satisfying a generally known sampling theorem. That is, a frequency that is twice or more the frequency band of the signal to observe is set as the sampling frequency. When the sampling frequency is set to 10 times or more the fundamental frequency f0 with respect to the fundamental frequency f0 of the ultrasonic beam U to be transmitted, it is preferable because distortion or the like of a signal waveform can be reproduced. In the present example, the sampling frequency was set to 50 MHz for a signal waveform of the fundamental frequency f0=0.86 MHz.

The frequency component H(ω) obtained by Expression (1) is a complex number. That is, the frequency component H(ω) has a phase in addition to an absolute value. The frequency spectrum illustrated in FIG. 12 is obtained by plotting an absolute value |H(ω)| of the complex number H(ω) with respect to the frequency ω.

Next, a method of calculating a signal feature from the frequency component H(ω) represented by a complex number will be described. First, h(t) is calculated in accordance with the following Expression (2).

$$\begin{matrix}[ Expression 2 ] & \\ {h}_{2} ( t ) = {\sum }_{ω} H ( ω ) exp ( j ω t ) & Expression ( 2 )\end{matrix}$$

$$\begin{matrix}[ Expression 3 ] & \\ h ( t ) = Re [ {h}_{2} ( t ) ] & Expression ( 3 )\end{matrix}$$

Here, j is an imaginary unit in Expression (2), and Re [ ] is processing of extracting a real part of a complex number in Expression (3). In Expression (2), a subscript w of the Z symbol indicates a frequency set of angular frequency components to be integrated. In Expression (2), the angular frequency components to be integrated are performed for an appropriately set frequency set {ω} as described later.

In Expression (2), a set {ω} of frequencies included in the integration is called a frequency parameter. The frequency parameter may be designated in the form of the frequency set {ω} or may be designated in the form of the frequency range. The frequency parameter may be set in advance. The frequency parameter may be input by the user.

h(t) obtained by Expression (3) is a signal waveform in the time domain synthesized from the frequency set having been set by the frequency parameter. The difference (peak-to-peak value) between the maximum value and the minimum value of this h(t) is set as the signal feature in the example of the present disclosure. In the example of the present disclosure, the difference between the maximum value and the minimum value (peak-to-peak value) is abbreviated as PP value.

In Expression (2), both H(ω) and exp(jωt) are complex numbers, and are calculated as complex numbers. That is, the signal feature is calculated in consideration of phase information on the frequency component H(ω). This is more preferable because the signal feature accurately reflecting the position information of the defect portion D can be obtained.

It is important to select the frequency parameter, that is, the set {ω} of frequencies included in the integration in Expression (2). The maximum component frequency fm is excluded from the set {ω} of frequencies included in the integration. By doing this, the filter unit 240 that reduces the maximum intensity frequency component can be configured. The frequency included in the integration includes the frequency of the skirt component W3 of the fundamental waveband W1. This can improve the detectability of the defect portion D in the inspection object E. It is more effective to remove also frequency components in the vicinity of the maximum component frequency fm.

Since the frequency f of the angular frequency ω can be converted in the relationship of ω=2πf, the frequency f is appropriately converted and interpreted. For example, description of “excluding the maximum component frequency fm from the set {ω} of frequencies” means “excluding ωm=2πfm”.

The maximum component frequency fm is a frequency at which the spectrum of the fundamental waveband W1 of the reception signal is maximized, but in the present disclosure, the maximum component frequency fm is a frequency at which the spectrum of the fundamental waveband W1 of the reception signal is substantially maximized.

In Expression (2), the set {ω} of frequencies included in the integration may include only frequencies lower than the maximum component frequency fm. Thus, the filter unit 240 having the characteristics of a low-pass filter can be configured. Similarly, only frequencies lower than the maximum component frequency fm may be included.

The frequency selection unit 242 appropriately sets the frequency parameter. In this manner, the frequency conversion unit 230 and the frequency selection unit 242 constitute the filter unit 240.

The frequency parameter may be set to an appropriate parameter in advance before inspection, or may be changed after measurement. Alternatively, the user may set one.

Note that the signal feature may be a value calculated from frequency component data so as to appropriately include the position information on the defect portion D, and is not limited to the above calculation method. In the above example, the PP value of the signal waveform h(t) in the time domain is the signal feature, but the absolute value of h(t) may be calculated, and the area of h(t) may be calculated to obtain the signal feature. Here, in the area calculation procedure, h(t) may be sampled at appropriate time intervals to calculate the sum of h(t) at sampling points. In place of the absolute value of h(t), a square value of h(t) may be used. Furthermore, in place of using Expressions (2) and (3), a value obtained by summing the absolute values of the frequency component H(ω) for the input frequency set {ω} may be used as the signal feature.

### Fifth Embodiment. Focal Length of Reception Probe 121

In the fifth embodiment, a focal length R2 of the reception probe 121 is longer than a focal length R1 of the transmission probe 110. This is more preferable because more components of the scattering wave U1 can be detected as described later. As described above, since the scattering wave U1 is the ultrasonic beam U interacting with the defect portion D, the defect portion D can be easily detected as the proportion of the components of the scattering wave U1 increases.

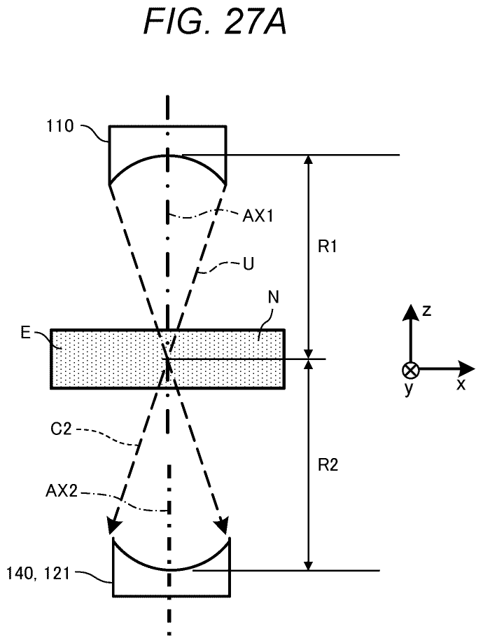

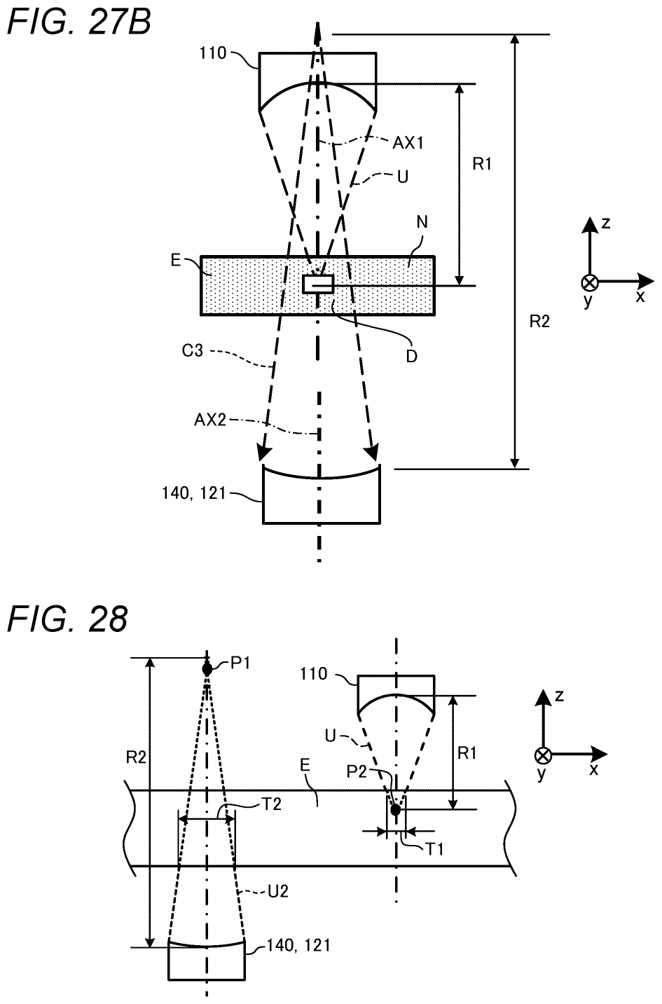

FIG. 27A is a view schematically illustrating the propagation path of the ultrasonic beam U in a case where the focal length R1 of the transmission probe 110 is equal to the focal length R2 of the reception probe 121 in the fifth embodiment. Both the transmission probe 110 and the reception probe 121 are of a line focus type, and FIG. 27A is a view of a scene in which the ultrasonic beam U converges as viewed from the side. However, the reception probe 121 may be of a point focus type or a non-convergence type. The reception probe 121 can detect the ultrasonic beam U within a range of a cone (shape) C2 of a virtual beam virtually emitted from the reception probe 121. In the example illustrated in FIG. 27A, a convergence line of the ultrasonic beam U transmitted from the transmission probe 110 is the same as a convergence line of the virtual beam virtually emitted from the reception probe 121. Therefore, the ultrasonic beam U whose propagation direction does not change in the defect portion D can be efficiently received. On the other hand, it is difficult to detect the ultrasonic beam U whose propagation direction has changed at the defect portion D.

FIG. 27B is a view schematically illustrating the propagation path of the ultrasonic beam U in a case where the focal length R2 of the reception probe 121 is longer than the focal length R1 of the transmission probe 110 in the fifth embodiment. The reception probe 121 can detect the ultrasonic beam U within a range of a cone (shape) C3 of a virtual beam virtually emitted from the reception probe 121. Therefore, even the scattering wave U1 (not illustrated in FIG. 27 B) in which the propagation direction is slightly changed at the defect portion D can be detected as long as it falls within the range of the cone C3. In this manner, the detectable scattering wave U1 can be increased by making the focal length R2 of the reception probe 121 longer than the focal length R1 of the transmission probe 110. As described above, since the scattering wave U1 is a wave interacting with the defect portion D, the detection performance of the defect portion D can be further improved by this.

The magnitude relationship of convergence is also defined by the magnitude relationship between beam injection areas T1 and T2 on the surface of the inspection object E. The beam injection areas T1 and T2 will be described.

FIG. 28 is a view describing the relationship between the beam injection area T1 in the transmission probe 110 and the beam injection area T2 in the reception probe 121. The beam injection area T1 on the inspection object E of the transmission probe 110 is an intersection area on the surface of the inspection object E of the ultrasonic beam U emitted from the transmission probe 110. The beam injection area T2 of the reception probe 121 is an intersection area of between the virtual ultrasonic beam U2 and the surface of the inspection object E assuming a case where the ultrasonic beam U is emitted from the reception probe 121.

Note that in FIG. 28, the path of the ultrasonic beam U indicates a path in a case where there is no inspection object E. When there is the inspection object E, the ultrasonic beam U is refracted on the surface of the inspection object E, and therefore the ultrasonic beam U propagates through a path different from the path indicated by the broken line. Here, in side view illustrated in FIG. 28, the beam injection area T2 on the inspection object E of the reception probe 121 is larger than the beam injection area T1 on the inspection object E of the transmission probe 110. In this way, the convergence of the reception probe 121 can be made looser than the convergence of the transmission probe 110.

Furthermore, the focal length R2 of the reception probe 121 is longer than the focal length R1 of the transmission probe 110. Also by doing this, the convergence of the reception probe 121 can be made looser than the convergence of the transmission probe 110. At this time, the distances from the inspection object E to the transmission probe 110 and the reception probe 121 are, for example, the same, but need not be the same.

In the example of the present disclosure, the convergence of the reception probe 121 is looser than the convergence of the transmission probe 110. That is, the focal length R2 of the reception probe 121 is set longer than the focal length R1 of the transmission probe 110. As a result, since the beam injection area T2 of the reception probe 121 is widened, the scattering wave U1 in a wide range can be detected. Due to this, even if the propagation path of the scattering wave U1 slightly changes, the scattering wave U1 can be detected by the reception probe 121. As a result, the defect portion D of a wide range can be detected.

A focal point P1 of the reception probe 121 is present on the transmission probe 110 side (above in the illustrated example) relative to a focal point P2 of the transmission probe 110. By shifting the focal points P1 and P2 in this manner, the scattering wave U1 can be easily received by the reception probe 121, and the scattering wave U1 can be easily detected.

Note that as a configuration in which the focal length R2 of the reception probe 121 is longer than the focal length R1 of the transmission probe 110, a non-convergence probe (not illustrated) may be used as the reception probe 121. In the non-convergence probe, since the focal length R2 is infinite, the focal length R2 is longer than the focal length R1 of the transmission probe 110. That is, also in the reception probe 121 of a non-convergence type, the convergence of the reception probe 121 is looser than the convergence of the transmission probe 110.

### Sixth Embodiment

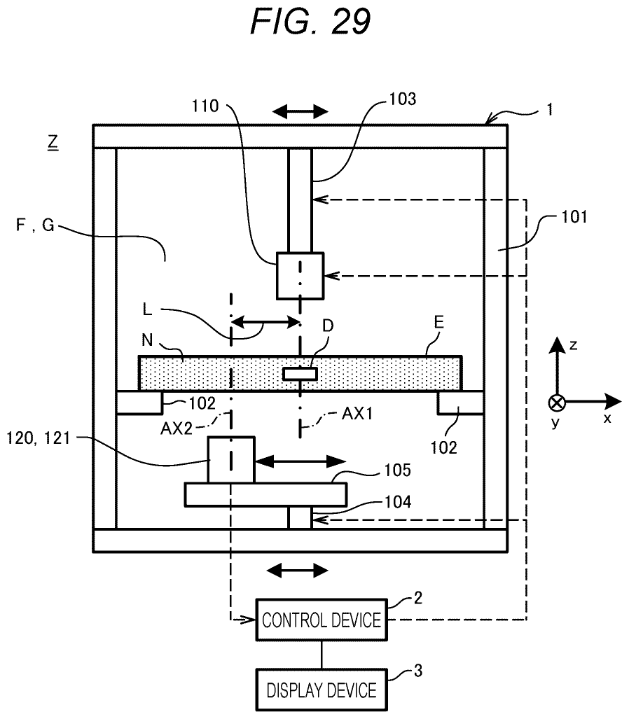

FIG. 29 is a view illustrating the configuration of the ultrasonic inspection device Z in the sixth embodiment. In the sixth embodiment, the transmission sound axis surface AX1 of the transmission probe 110 and the reception sound axis AX2 of the reception probe 121 are arranged to be shifted from each other. That is, the reception probe 121 in the sixth embodiment is the reception probe 120 (eccentric arrangement reception probe) having the reception sound axis AX2 arranged at a position different from the transmission sound axis surface AX1 of the transmission probe 110. Therefore, the eccentric distance L (distance) between the transmission sound axis surface AX1 (sound axis surface) of the transmission probe 110 and the reception sound axis AX2 (sound axis) of the reception probe 120 is larger than zero.

Such an arrangement can detect a wave whose spatial direction has changed among the scattering waves U1. In the present embodiment, the direct wave U3 travels along the transmission sound axis surface AX1 and is not injected to the reception probe 121. Therefore, even if the irradiation area of the ultrasonic beam U is increased by using the transmission probe 110, the scattering wave U1 component caused by the defect portion D can be effectively detected. In this manner, using the transmission probe 110, the minute defect portion D can be detected.

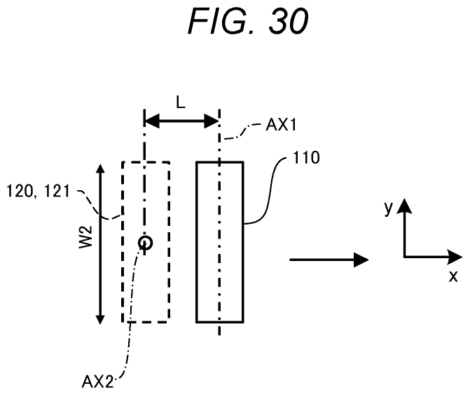

FIG. 30 is a plan view illustrating the relative positional relationship between the transmission probe 110 and the reception probe 121. In FIG. 30, since the reception probe 121 is on the opposite side of the transmission probe 110 across the inspection object E, the reception probe 121 is indicated by the dotted line. The eccentric distance L between the transmission sound axis surface AX1 of the transmission probe 110 and the reception sound axis AX2 of the reception probe 121 is arranged to be larger than zero. Here, the reception probe 121 is arranged at a position shifted in a direction substantially perpendicular to the long axis direction (the y-axis direction in the drawing) of the transmission probe 110. With this arrangement, the scattering wave U1 can be received regardless of whatever position in the line converging beam having the length W2 in the long axis direction the defect portion D exists. Note that the scan axis 131, which is a direction for scanning the transmission probe 110, intersects the long axis 130 of the transmission probe 110 in a substantially perpendicular direction.

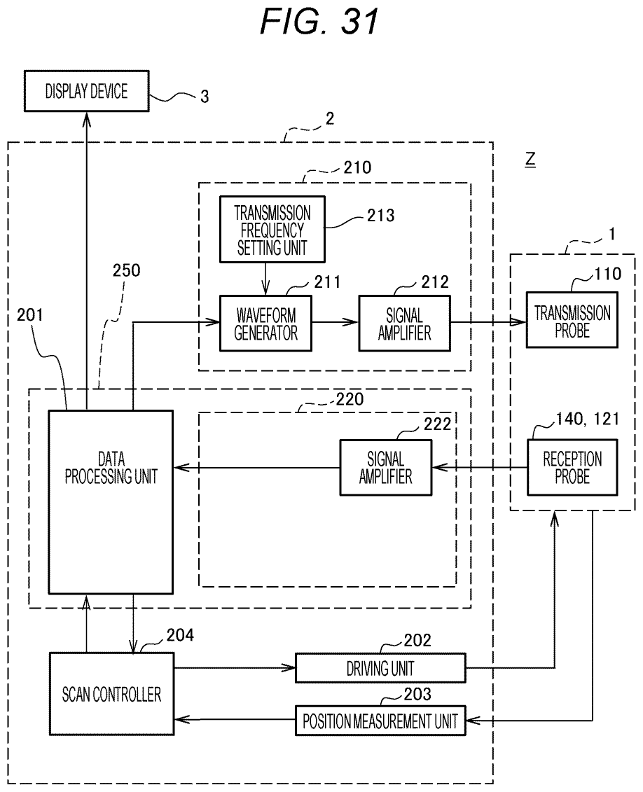

FIG. 31 is a functional block diagram of the control device 2 in the ultrasonic inspection device Z in the sixth embodiment. In the present embodiment, the position of the reception probe 121 is shifted from the transmission sound axis surface AX1. Due to this, since the direct wave component is reduced, it is not necessary to provide a filter unit. Therefore, the signal is directly input from the signal amplifier 222 to the data processing unit 201.

In the normal portion N, since the ultrasonic beam U emitted from the transmission probe 110 does not reach the reception probe 121, the ultrasonic beam U is not observed as a reception signal. Since the scattering wave U1 component occurs in the defect portion D, the scattering wave U1 is injected onto the reception probe 121, and a signal component is detected. As described above, in the present embodiment, since detection of the direct wave U3 is spatially prevented by shifting the position of the reception probe 121, the scattering wave U1 component can be extracted without providing a filter unit. Due to this, even using the transmission probe 110, the minute defect portion D can be detected.

In the present embodiment, it is not necessary to shift the excitation frequency fex from the natural oscillation frequency of the transmission probe 110.

However, although not illustrated in FIG. 31, a configuration may be used in which the eccentric distance L of the reception probe 121 is made larger than zero, and an appropriate frequency range is extracted and detected using the filter unit 240. Due to this, reduction of the direct wave U3 is reduced by the spatial method and the frequency method, which is more effective.

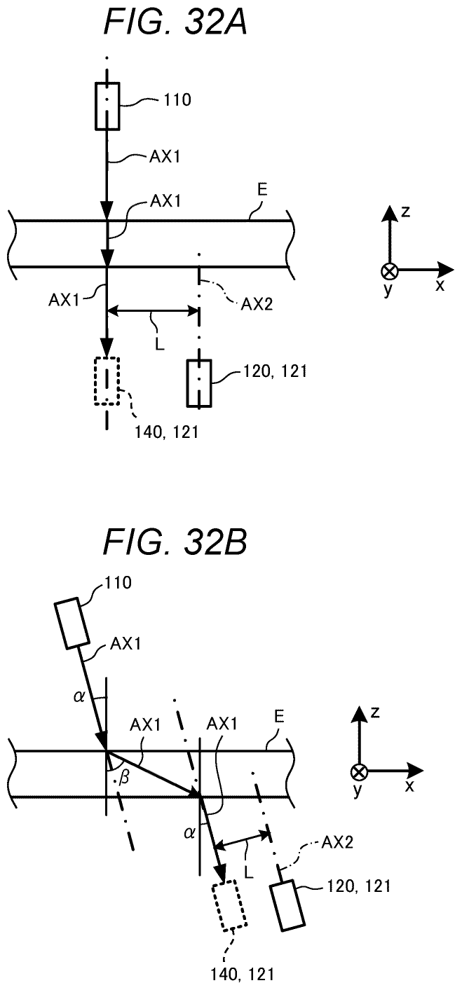

FIG. 32A is a view describing the transmission sound axis surface AX1, the reception sound axis AX2, and the eccentric distance L, and illustrates a case where the transmission sound axis surface AX1 and the reception sound axis AX2 extend in the vertical direction. FIG. 32B is a view describing the transmission sound axis surface AX1, the reception sound axis AX2, and the eccentric distance L, and illustrates a case where the transmission sound axis surface AX1 and the reception sound axis AX2 extend in an inclined manner. In FIGS. 32A and 32B, the reception probe 140 (coaxial arrangement reception probe) is also illustrated by the broken line for reference.

The direction of the reception sound axis AX2 is the normal direction of the probe surface 114 (FIG. 4A). This is because the virtual ultrasonic beam U emitted from the reception probe 121 is extracted in the normal direction of the probe surface 114. Also when the ultrasonic beam U is received, the ultrasonic beam U to be injected in the normal direction of the probe surface 114 can be received with high sensitivity.

The eccentric distance L is defined by a distance of shift between the transmission sound axis surface AX1 and the reception sound axis AX2. Therefore, as illustrated in FIG. 32B, when the ultrasonic beam U emitted from the transmission probe 110 is refracted, the eccentric distance L is defined by the distance of the shift between the refracted transmission sound axis surface AX1 and the reception sound axis AX2. In the ultrasonic inspection device Z of the sixth embodiment, the transmission probe 110 and the reception probe 120 are adjusted by a distance adjustment unit 105 (FIG. 29) that adjusts the eccentric distance L such that the thus defined eccentric distance L becomes a distance larger than zero. The distance adjustment unit 105 is included in the ultrasonic inspection device Z, and adjusts the eccentric distance L between the transmission sound axis surface AX1 of the transmission probe 110 and the reception sound axis AX2 of the reception probes 121 and 120 to a distance greater than zero.

FIG. 32A illustrates a case where the transmission probe 110 is arranged in the normal direction on the surface of the inspection object E. In FIGS. 32A and 32B, the transmission sound axis surface AX1 is indicated by the solid arrows. The reception sound axis AX2 is indicated by the dash-dot arrow. Note that in FIGS. 32A and 32B, the position of the reception probe 121 indicated by the broken line is the position where the eccentric distance L is zero, and the reception probe 121 in which the transmission sound axis surface AX1 and the reception sound axis AX2 coincide with each other is the reception probe 140 as a coaxial arrangement reception probe. The reception probe 121 indicated by the solid line is the reception probe 120 (eccentric arrangement reception probe) arranged at a position with the eccentric distance L larger than zero. When the transmission probe 110 is installed such that the transmission sound axis surface AX1 is perpendicular to a horizontal plane (xy plane in FIG. 29), the propagation path of the ultrasonic beam U is not refracted. That is, the transmission sound axis surface AX1 is not refracted. This corresponds to a case where the transmission probe 110 is installed such that the transmission sound axis surface AX1 of the transmission probe 110 is perpendicular to the placement surface 1021 of the sample stage 102.

In the present embodiment, the transmission probe 110 is installed such that the transmission sound axis surface AX1 is in the normal direction of the placement surface 1021 of the inspection object E on the sample stage 102. As described above, in the inspection object E having a plate shape, since the transmission sound axis surface AX1 is disposed perpendicularly to the surface of the inspection object E, there is an effect that the correspondence relationship between the scanning position and the position of the defect portion D is easily understood.

FIG. 32B illustrates a case where the transmission probe 110 is disposed to be inclined by an angle α from the normal direction on the surface of the inspection object E. Also in FIG. 32B, similarly to FIG. 32A, the transmission sound axis surface AX1 is indicated by the solid arrow, and the reception sound axis AX2 is indicated by the dash-dot arrow. In a case of the example illustrated in FIG. 32B, the propagation path of the ultrasonic beam U is refracted at a refraction angle β at an interface between the inspection object E and the fluid F. Therefore, the transmission sound axis surface AX1 is bent (refracted) as indicated by the solid arrow in FIG. 32B. In this case, since the position of the reception probe 140 indicated by the broken line is positioned on the transmission sound axis surface AX1, the eccentric distance L is at a position of zero. As described above, even when the ultrasonic beam U is refracted, the reception probe 120 is arranged such that the distance between the transmission sound axis surface AX1 and the reception sound axis AX2 is L. Note that in the example illustrated in FIG. 29, since the transmission probe 110 is installed in the normal direction on the surface of the inspection object E, the eccentric distance L is as illustrated in FIG. 31A.

The eccentric distance L is more preferably set at a position where the signal intensity at the defect portion D is larger than that of the reception signal at the normal portion N of the inspection object E.

### Seventh Embodiment

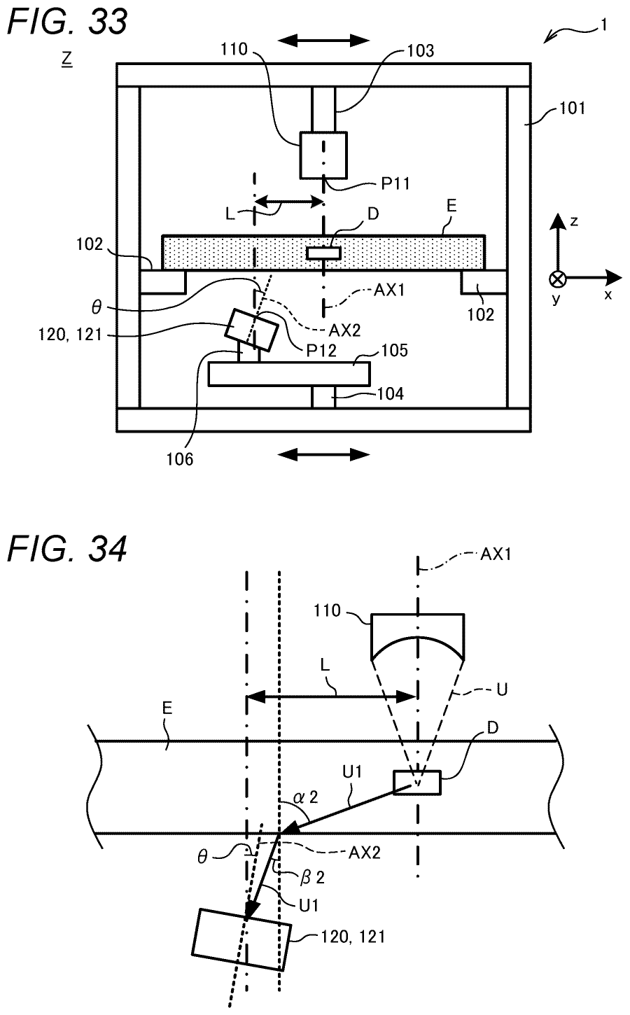

FIG. 33 is a view illustrating the configuration of the ultrasonic inspection device Z in the seventh embodiment. In the seventh embodiment, the scanning measurement device 1 includes an installation angle adjustment unit 106 that adjusts an inclination of the reception probe 120. This can increase the intensity of the reception signal, and increase a signal to noise ratio (SN ratio) of the signal. The installation angle adjustment unit 106 includes, for example, an actuator and a motor that are not illustrated.

Here, an angle θ formed by the transmission sound axis surface AX1 and the reception sound axis AX2 is defined as a reception probe installation angle. In the case of FIG. 33, since the transmission probe 110 is installed in the vertical direction, the transmission sound axis surface AX1 is in the vertical direction, and thus, the angle θ, which is the reception probe installation angle, is an angle formed by the transmission sound axis surface AX1 (i.e., the vertical direction) and the normal line of the probe surface of the reception probe 120. Then, the installation angle adjustment unit 106 inclines the angle θ on the side where the transmission sound axis surface AX1 exists, and sets the angle θ to a value larger than zero. That is, the reception probe 120 is arranged in an inclined manner. Specifically, the reception probe 120 is inclined so as to satisfy 0°<θ<90°, and the angle θ is, for example, 10°, but is not limited to this.

When the present inventor actually detected the defect portion D by thus arranging the reception probe 120 in an inclined manner, the signal intensity of the reception signal increased to 3 times as compared with the case of 0=0.

The eccentric distance L when the reception probe 120 is arranged in an inclined manner is defined as follows. An intersection point P12 between the reception sound axis AX2 and the probe surface of the reception probe 120 is defined. An intersection point P11 between the transmission sound axis surface AX1 and the probe surface of the transmission probe 110 is defined. A distance between a coordinate position (x4, y4) (not illustrated) obtained by projecting the position of the intersection point P11 onto the xy plane and a coordinate position (x5, y5) (not illustrated) obtained by projecting the position of the intersection point P12 onto the xy plane is defined as the eccentric distance L.

FIG. 34 is a view describing a reason for the effect by the seventh embodiment to occur. The scattering wave U1 propagates in a direction off from the transmission sound axis surface AX1. Therefore, as illustrated in FIG. 34, when the scattering wave U1 reaches the outside of the inspection object E, the scattering wave U1 is injected onto the interface between the inspection object E and the outside at an angle α2 that is non-zero from the normal vector of the surface of the inspection object E. The angle of the scattering wave U1 emitted from the surface of inspection object E has an angle β2 that is a non-zero extraction angle with respect to the normal direction of the surface of inspection object E. The scattering wave U1 can be received most efficiently when the normal vector of the probe surface of the reception probe 120 coincides with the traveling direction of the scattering wave U1. That is, the reception signal intensity can be increased by arranging the reception probe 120 in an inclined manner.

Note that when the angle β2 of the ultrasonic beam U extracted from the inspection object E coincides with the angle θ formed by the transmission sound axis surface AX1 and the reception sound axis AX2, the reception effect becomes the highest. However, even in a case where the angle β2 and the angle θ do not completely coincide with each other, since the effect of the reception signal increase can be obtained, the angle β2 and the angle θ do not need to completely coincide with each other as illustrated in FIG. 34.

### Eighth Embodiment

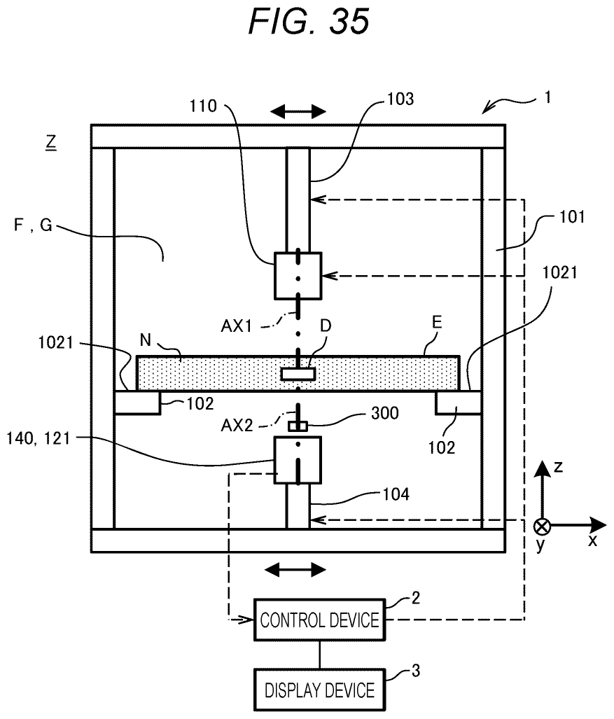

FIG. 35 is a view illustrating the configuration of the ultrasonic inspection device Z in the eighth embodiment. In the present embodiment, the ultrasonic inspection device Z includes an acoustic wave shielding member 300. The acoustic wave shielding member 300 shields the ultrasonic beam U from the transmission probe 110 toward the reception probe 121. The acoustic wave shielding member 300 is included on the transmission sound axis surface AX1 of the transmission probe 110 between the inspection object E and the reception probe 121.

By arranging the acoustic wave shielding member 300 on the transmission sound axis surface AX1, the ultrasonic beam U (direct wave U3) to be injected onto the reception probe 140 along the transmission sound axis surface AX1 of the transmission probe 110 can be shielded. In this way, it is possible to remove the direct wave U3 component from the reception signal and increase the proportion of the scattering wave U1 in the reception signal. As described above, since the scattering wave U1 contains many pieces of information on the defect portion D, the detectability of the defect portion D can be further improved according to the present embodiment.

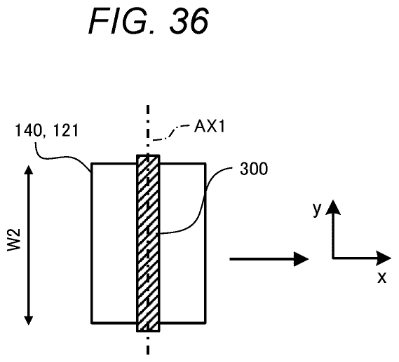

FIG. 36 is a plan view illustrating the positional relationship between the reception probe 121 and the acoustic wave shielding member 300.

In the present embodiment, as the size of the acoustic wave shielding member 300 having a rectangular shape, for example, the width (length in the short axis direction of the reception probe 121) of the acoustic wave shielding member 300 is made a width including the transmission sound axis surface AX1 of the ultrasonic beam U, and made smaller than the width of the reception probe 121. In the present embodiment, the width is, for example, 3 mm, and the length (length in the long axis direction of the reception probe 121) of the acoustic wave shielding member 300 is equal to or longer than the length W2 in the long axis direction of the transmission probe 110, but it goes without saying that the size is not limited to this. As illustrated in FIG. 36, the acoustic wave shielding member 300 was installed so as to include the transmission sound axis surface AX1. With such an arrangement, the direct wave U3 of a line convergence beam can be effectively shielded, and only the scattering wave U1 component can be received. This can reduce interference by the direct wave U3 component in the reception signal, and thus, it is possible to detect the minute defect portion D even using the transmission probe 110.

The size of the acoustic wave shielding member 300 can be determined by, for example, experiment, simulation, or the like in accordance with, for example, the beam diameter of the ultrasonic beam U, the physical properties (e.g., the material) of the inspection object E, the frequency of the ultrasonic beam U, and the like. The reception probe 140 can receive more scattering wave U1 components by using a non-convergence probe.

In the present embodiment, the reception sound axis AX2 can adopt a coaxial arrangement coinciding with the transmission sound axis surface AX1. However, the reception sound axis AX2 and the transmission sound axis surface AX1 may substantially coincide with each other (or may completely coincide with each other).

The material of the acoustic wave shielding member 300 may be any material as long as it reduces transmission of the ultrasonic beam U, and for example, metal (stainless steel or the like), a resin material, or the like can be used. The acoustic wave shielding member 300 may be attached and installed on the surface of the reception probe 121.

Also in the eighth embodiment, the control device 2 illustrated in FIG. 31 can be used. Also in the eighth embodiment, similarly to the sixth embodiment described with reference to FIG. 31, the direct wave U3 component is reduced by shifting the position of the reception probe 121 from the transmission sound axis surface AX1. Therefore, it is not necessary to provide a filter unit. It is not necessary to shift the excitation frequency fex from the natural oscillation frequency of the transmission probe 110.

Furthermore, similarly to the sixth embodiment, by setting the eccentric distance L of the reception probe 121 to zero or more and extracting and detecting an appropriate frequency range using the filter unit 240, reduction of the direct wave U3 is performed by the spatial method and the frequency method, which is more effective.

### Ninth Embodiment

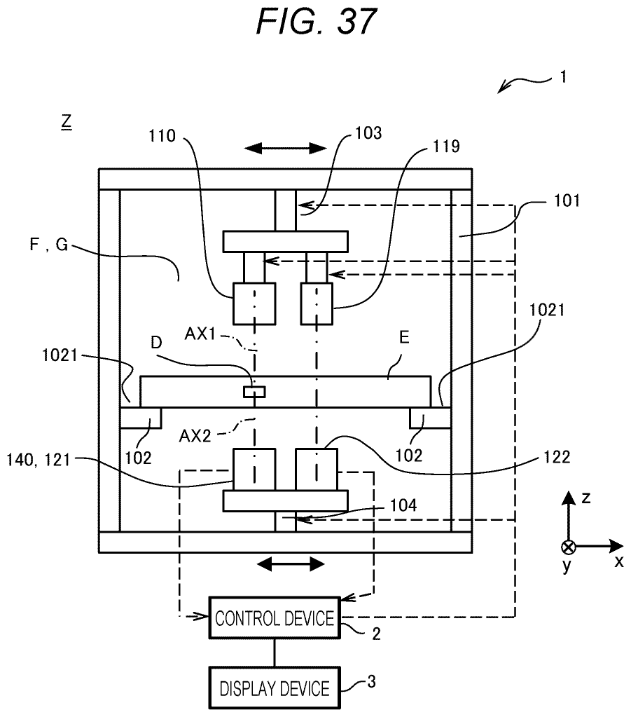

FIG. 37 is a view schematically illustrating the ultrasonic inspection device Z of the ninth embodiment.

In the present embodiment, the scanning measurement device 1 includes the transmission probe 119 (second transmission probe) of a point focus type in addition to the transmission probe 110 of a line focus type. The transmission probe 119 emits the point-converging ultrasonic beam U toward the inspection object E. By including the transmission probe 110, a two-dimensional position of the defect portion D can be known.

In the embodiment illustrated in FIG. 37, the scanning measurement device 1 includes the transmission probe 119 in addition to the embodiment of FIG. 1, and the transmission probe 119 is attached to the transmission probe scanning unit 103. The scanning measurement device 1 includes a reception probe 122 (second reception probe) having the same configuration as the reception probe 121, and is installed on the opposite side to the transmission probe 119 with respect to the inspection object E. In the illustrated example, the reception probe 121 is installed immediately below the transmission probe 119. The reception probe 122 is fixed to the reception probe scanning unit 104. In this manner, the transmission probe 119 (second transmission probe) and the reception probe 122 scan in the xy plane while keeping relative positions.

The transmission probe 119 is a transmission probe of a point focus type (point convergence type). The reception probe 122 is a non-convergent reception probe in the present example. Thus, by using the focal length of the reception probe 122 longer than the focal length of the transmission probe 119 of a point focus type, the scattering wave U1 can be efficiently detected, which is more preferable for detecting the minute defect portion D. However, a reception probe of point focus type may be used as the reception probe 122.

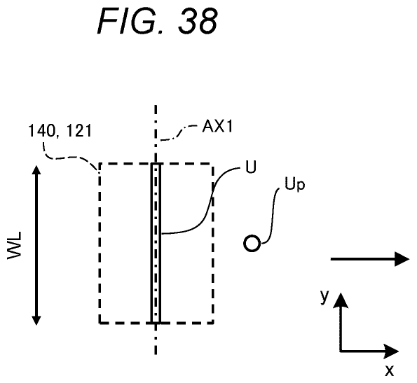

FIG. 38 is a plan view illustrating the positional relationship between the ultrasonic beam U emitted from the transmission probe 110 of a line focus type and an ultrasonic beam Up emitted from the transmission probe 119 of a point focus type. FIG. 38 illustrates a beam shape at a position corresponding to the vicinity of the focal points of the ultrasonic beams U and Up, and therefore the ultrasonic beam U has a linear shape and the ultrasonic beam Up has a dot shape. Since the reception probes 140 and 121 corresponding to the transmission probe 110 are installed on the opposite side with respect to the inspection object E, the positions of the reception probes 140 and 121 are indicated by the dotted lines.

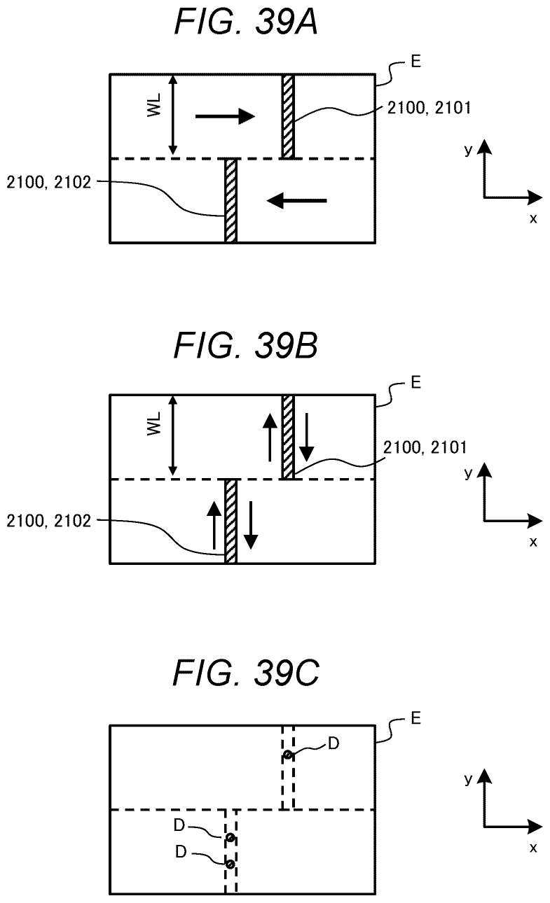

FIG. 39A is a view illustrating an imaging process of a defect image. FIG. 39B is a view illustrating a process performed subsequent to the process illustrated in FIG. 39A. FIG. 39C is a view illustrating a process performed subsequent to the process illustrated in FIG. 39B. A defect imaging process in the present embodiment will be described with reference to FIGS. 39A, 39B, and 39C. For ease of explanation, the size of the inspection object E is assumed to be 40 mm×60 mm, and the length WL, which is the width of the long axis of the ultrasonic beam U emitted by the transmission probe 110, is assumed to be 20 mm.

First, as indicated by the solid black arrow of FIG. 39A, the inspection object E is scanned from left to right in the transmission probe 110 in the upper half (upper half of the paper sheet in FIG. 39A) of the inspection object E, and then the inspection object E is scanned from right to left in the lower half (lower half of the paper sheet in FIG. 39A) of the inspection object E. Thus, the entire inspection object E can be inspected. At this time, a defect signal appears at a place where the defect portion D exists. The place where the defect signal is detected is called a defect detection region 2100. FIG. 39A illustrates a case where two defect detection regions 2101 and 2102 exist as the defect detection region 2100. When defect detection is performed using a line convergence beam, the defect signal indicates that a defect exists at any place within the range of the length WL, and therefore the defect detection regions 2101 and 2102 are regions having a width of the length WL.

Next, as indicated by the solid black arrows of FIG. 39B, only the defect detection regions 2101 and 2102 are inspected. The inspection is performed by scanning using the transmission probe 119 of a point focus type and the reception probe 122 of a non-convergence type. In many cases, the defect detection regions 2101 and 2102 are rectangular regions extending in the long axis direction of the transmission probe 110. Therefore, as indicated by the solid black arrow in FIG. 39B, when scanning is performed in a direction (y-axis direction in the drawing) perpendicular to the scan axis when scanning is performed by the transmission probe 110, the defect detection regions 2101 and 2102 can be scanned with a small number of turns, which is more preferable.

Finally, as illustrated in FIG. 39C, the xy position of the defect portion D in the defect detection regions 2101 and 2102 can be known by scanning the defect detection regions 2101 and 2102 using the transmission probe 119 and the reception probe 122. The defect portion D is imaged using the obtained xy position of the defect portion D.

As described above, in the ninth embodiment, the defect detection regions 2101 and 2102 in which the defect signal is detected by scanning the transmission probe 110 of a line focus type scan the transmission probe 119 of a point focus type to image the defect portion D. Due to this, the xy position of the defect portion D can be imaged at high speed and with high accuracy.

### Tenth Embodiment

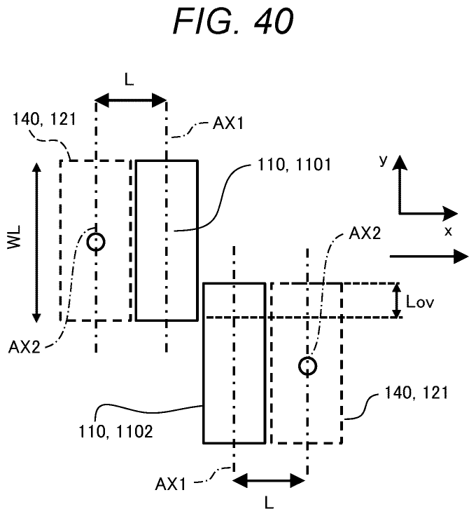

FIG. 40 is a view illustrating the configuration of the transmission probe 110 of a line focus type in the tenth embodiment.

The longer the length WL in the long axis direction of the transmission probe 110 is, the more the area to be inspected in one scan increases, and therefore high-speed inspection is possible. On the other hand, since the length WL is long, the piezoelectric transducer included in the transmission probe 110 becomes large. Therefore, the length WL that can be created has constraints in terms of cost and technology.

Therefore, in the present embodiment, the transmission probe 110 of a line focus type includes a plurality of unit probes 1101 and 1102 of a line focus type. The number of unit probes may be 3 or more. Due to this, the plurality of unit probes 1101 can be combined to extend the length WL into the long axis direction. Since the reception probes 121 and 140 are positioned on the opposite side of the transmission probe 110 (unit probe 1101) with respect to the inspection object E, they are indicated by the dotted lines.

The unit probe 1102 is arranged to be shifted from the unit probe 1101 in the scan axis direction. In other words, the unit probes 1101 and 1102 are arranged such that the respective transmission sound axial planes AX1 are shifted. That is, the respective transmission sound axis surfaces AX1 of the unit probes 1101 and 1102 are arranged to be shifted in the scan axis direction.

The unit probe 1101 and the unit probe 1102 are arranged so as to partially overlap each other in the long axis direction (y-axis direction in the drawing). That is, parts of the respective transmission sound axis surfaces AX1 of the unit probes 1101 and 1102 overlap in front view (viewed in the x-direction) of the transmission sound axis surface AX1. In other words, the overlap amount of the unit probes 1101 and 1102 in the long axis direction is larger than zero. Therefore, at the time of scanning by the transmission probe 110, scanning is performed such that a part of the ultrasonic beam U emitted from the unit probe 1101 and a part of the ultrasonic beam U emitted from the adjacent unit probe 1102 overlap each other. Specifically, for example, the end of a first ultrasonic beam U and the end on the first ultrasonic beam U side of a second ultrasonic beam U adjacent to the first ultrasonic beam U overlap each other. The first ultrasonic beam U is emitted from the unit probe 1101, and the second ultrasonic beam U is emitted from the unit probe 1102.

In FIG. 40, the transmission sound axis surfaces AX1 overlap each other such that the overlap length Lov between the both is a positive value. Thus, by setting the overlap amount in the long axis direction of the unit probes 1101 and 1102 to be larger than zero, the ultrasonic beam U is reliably emitted even in the region between the two adjacent unit probes 1101 and 1102, and it is possible to eliminate inspection omission, which is preferable.

The positions of the reception probes 121 and 140 are also similar to the positions of the unit probes 1101 and 1102. Therefore, the positions of the reception probes 121 and 140 are arranged such that the reception sound axis AX2 is shifted from the transmission sound axis surface AX1 in FIG. 40. In this way, the direct wave U3 component of the ultrasonic beam emitted from the unit probes 1101 and 1102 is not injected on the reception probes 121 and 140, and therefore the scattering wave U1 at the defect portion D is easily detected, and the minute defect portion D can be detected.

In order to prevent the direct wave U3 component from being injected to the reception probes 121 and 140, the transmission sound axis surface AX1 is arranged not to intersect the reception surfaces of the reception probes 121 and 140. Therefore, as in FIG. 40, the two reception probes 121 and 140 are arranged on the opposite sides to each other in the scan axis direction with respect to the unit probes 1101 and 1102.

FIG. 40 illustrates the configuration in which the direct wave U3 component is reduced by shifting the transmission sound axis surface AX1 and the reception sound axis AX2. Alternatively, as described in the first embodiment, the direct wave U3 component can be reduced also by shifting the excitation frequency fex from the natural frequencies of the unit probes 1101 and 1102 and setting the reception signal to an appropriate frequency range using the filter unit 240. In this case, it is not always necessary to arrange the transmission sound axis surface AX1 and the reception sound axis AX2 to be shifted from each other.

### (Drive Sequence)

In the tenth embodiment, the control device 2 having the configuration of FIG. 10 can be used. However, the signal amplifier 212 has two output terminals, and the output terminals are connected to the unit probes 1101 and 1102, respectively. The signal amplifier 222 in the reception system 220 also has two input terminals, and the input terminals are connected to the unit probes 1101 and 1102, respectively.

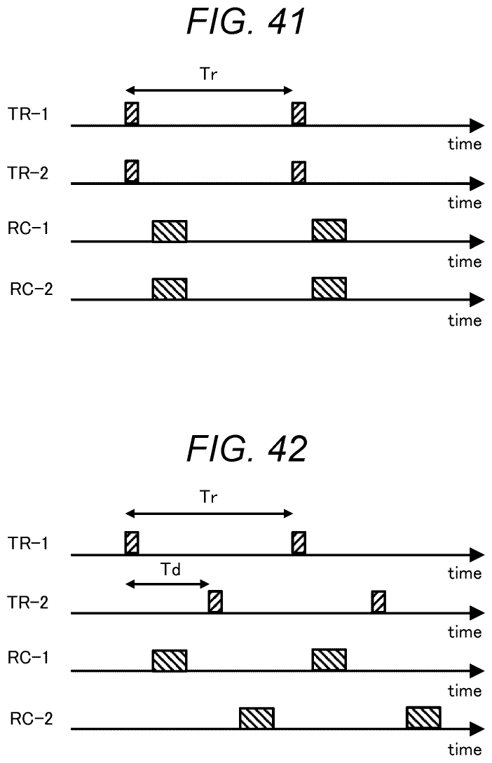

FIG. 41 is a timing chart illustrating the drive sequence in the configuration using the two unit probes 1101 and 1102. The horizontal axis in the drawing indicates the elapsed time. Vertical items TR-1 and TR2 indicate drive sequences of the unit probes 1101 and 1102, respectively. Vertical items RC-1 and RC-2 indicate reception timing sequences of the reception probes 140 and 121 installed below the unit probes 1101 and 1102, respectively.

In the drawing, hatched parts in the waveforms (TR-1 and TR-2) of the unit probes 1101 and 1102 indicate wave packets of burst wave voltages applied to the unit probes 1101 and 1102, respectively. The repetition period Tr of the wave packet is preferably 0.5 ms to 10 ms, and is 5 ms in the present embodiment.

Hatched parts in the timing charts (RC-1 and RC2) of the reception probes 140 and 121 indicate the reception period. The reception period is a period in which signals of the ultrasonic beam U injected on the reception probes 140 and 121 are acquired. The reception period is typically a period of 0.1 ms to 2 ms after the wave packets of the corresponding unit probes 1101 and 1102 end. In the present embodiment, the reception period is 0.5 ms. The length of the reception period is mainly determined by the time required for the ultrasonic beam U to reach the distance from the unit probes 1101 and 1102 to the reception probes 140 and 121. Therefore, a suitable length of the reception period varies depending on the substance of the fluid F, the installation positions of the unit probes 1101 and 1102 and the reception probes 140 and 121, and the like.

As described above, in the example of FIG. 41, the ultrasonic beam U is emitted at the same time by all the unit probes 1101 and 1102, and the ultrasonic beam U is received at the same time by all the reception probes 140 and 121. In this way, not only in a case where the number of unit probes is a small number, for example, 2 or less, but also in a case where the number of unit probes is a large number, for example, 3 or more, the scanning speed can be increased, and the inspection can be performed in a short time.

FIG. 42 is a timing chart illustrating the drive sequence in another embodiment of the tenth embodiment. In this example, inside the signal amplifier 212, two signals are output by electronically switching one signal amplifier circuit by a switch such as a relay. The signal amplifier 222 of the reception system 220 also includes one signal amplifier circuit and an electronic switch inside the signal amplifier 222, and processes two input signals.

As illustrated in FIG. 42, after the unit probe 1101 (TR-1) is applied with a wave packet of a burst wave, a reception period is set for the corresponding reception probes 140 and 121 (RC-1). Next, the unit probe 1102 (TR-2) is applied with a wave packet, and then a reception period is set for the corresponding reception probes 140 and 121 (RC-2). A delay time Td between the wave packet of TR-1 and the wave packet of TR-2 is typically 0.2 ms to 2 ms.

As described above, in the example of FIG. 42, first, emission and reception of the ultrasonic beam U are performed using the pair of unit probes 1101 and the reception probe 140. Next, after at least the emission of the ultrasonic beam U, emission and reception of the ultrasonic beam U are performed using another pair of the unit probe 1102 and the reception probe 140. Emission of the ultrasonic beam U from another pair of unit probes 1102 may be performed before or after reception of the ultrasonic beam U by the pair of unit probes 1101 and the reception probe 140.

By using the drive sequence in this manner, two transmission outputs are not simultaneously performed, and therefore an electronic switch can cope with the two transmission outputs. The same applies to a reception circuit. According to this configuration, there is an effect that the transmission circuit and the reception circuit can be configured at low cost.

### Eleventh Embodiment

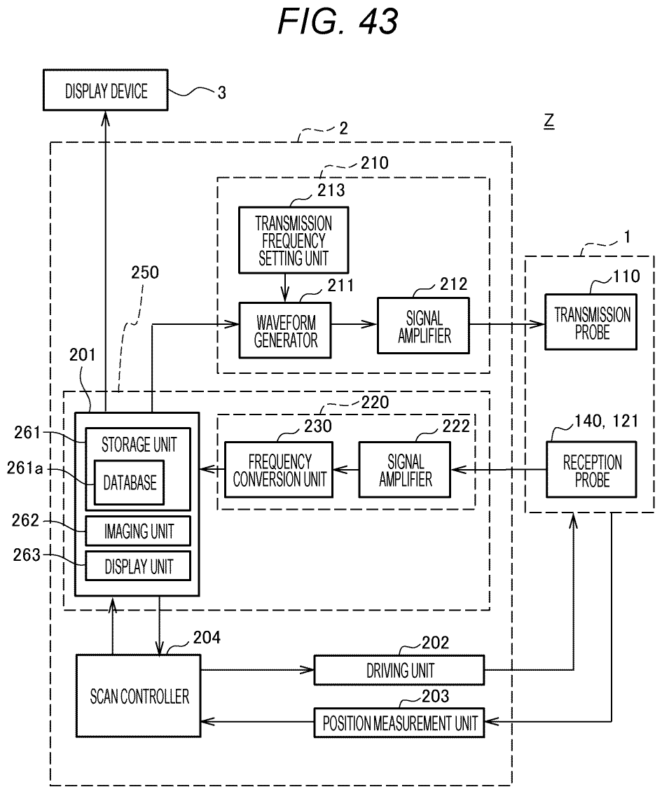

FIG. 43 is a functional block diagram of the control device 2 of the eleventh embodiment.

### (Accumulation of Frequency Component Data)

The data processing unit 201 includes the storage unit 261, the imaging unit 262, and the display unit 263. The storage unit 261 includes a database 261a. Therefore, the signal processing unit 250 includes the frequency conversion unit 230, the imaging unit 262, the database 261a, and the display unit 263.

In the example of the present disclosure, the control device 2 includes the database 261a in the storage unit 261 constituting the data processing unit 201. The database 261a associates, with frequency parameters, information (hereinafter, called “information regarding the inspection object E”) affecting the detection accuracy of the defect portion D in the inspection object E. The information mentioned here includes, for example, an inspection condition of the inspection object E. Depending on the inspection condition, an appropriate frequency parameter can be different. The appropriate frequency parameter mentioned here is a frequency parameter for making a difference between the frequency spectrum of the normal portion N and the frequency spectrum of the defect portion D large enough to be detectable the defect portion D. The frequency parameter indicates a frequency set {ωn} suitable for detection of the defect portion D. Therefore, by inputting the inspection condition to an input section 272 (described later), the user can designate a part of the frequency spectrum to be used for creation of the image 273 (described later).

Note that in the present embodiment, it is more preferable that the excitation frequency fex used for the frequency parameter is added to and saved in the database 261a. Detection performance of the defect portion D varies depending on how high the excitation frequency fex is shifted from the natural frequency fres of the transmission probe 110. Therefore, by registering also the excitation frequency fex (shifted amount) into the database 261a, it is possible to select an appropriate excitation frequency fex at the time of subsequent measurement.

Note that when the used excitation frequency fex is registered as the frequency parameter, the shift amount from the natural frequency fres is so important that the shift amount is preferably registered in the form of a difference amount Δfex=fex−fres. Furthermore, it is preferable to register a ratio (Δfex/fres) between the difference amount Δfex and the natural frequency fres.

The inspection condition includes, for example, at least one of a material of the inspection object E, a thickness of the inspection object E, a structure of the inspection object E (e.g., a single layer structure or a multilayer structure), a position of the inspection object E with respect to the reception probe 121 and the transmission probe 110 (e.g., a position in the z-direction), and a type of the fluid F. Since these are information that can affect appropriate frequency parameters, an appropriate frequency parameter can be determined by the user inputting at least one of these.

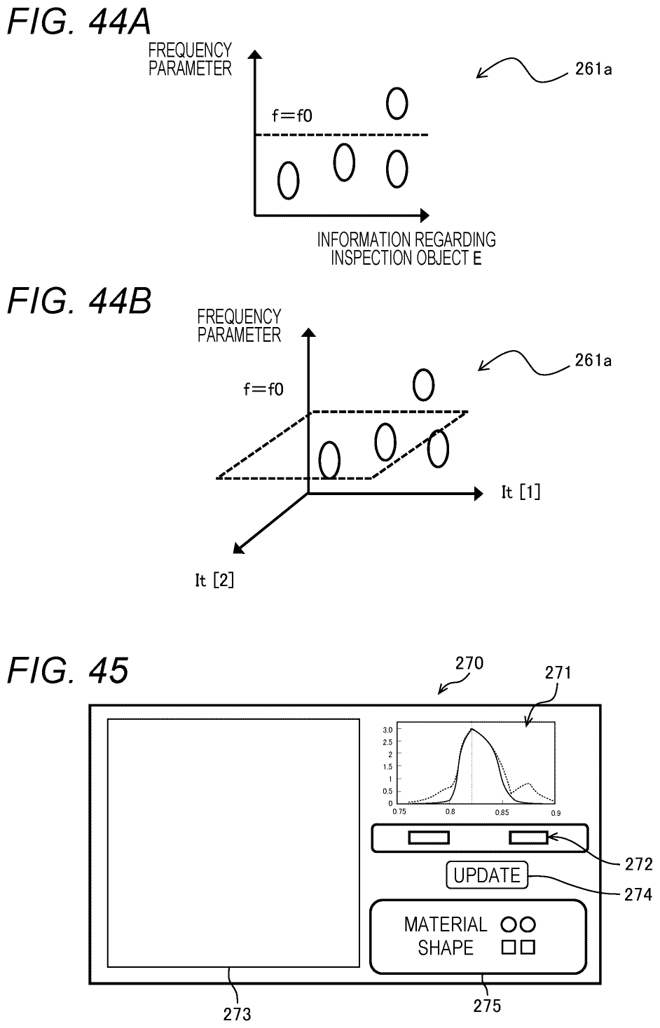

FIG. 44A is an example of the database 261a. In the example of the present disclosure, the frequency parameter is a set of a ratio f/f0 to the transmission frequency f0 (FIG. 14). In the example illustrated in FIG. 44, a suitable frequency parameter for the information regarding the inspection object E is expressed as a certain range. The information mentioned here is, for example, a thickness and a material of the inspection object E as an example for description. When measurement is performed by the ultrasonic inspection device Z illustrated in FIG. 1 and a suitable frequency parameter is repeatedly registered, that is, updated, information is accumulated in the database 261a.

FIG. 44B is a view three-dimensionally illustrating the database 261a illustrated in FIG. 44A. The information regarding the inspection object E is multidimensional information having a plurality of axes. That is, when the information regarding the inspection object E is expressed by being divided into each component It[k](k is an integer of 1 or more), k=1, 2, . . . corresponds to each axis of the multidimensional information. In the example illustrated in FIG. 44B, as an example for description, It[1] is the thickness of the inspection object E, and It[2] is the material of the inspection object E.

In FIG. 44, information regarding the inspection object E, which is multidimensional information, is abstracted as one axis. Specifically, as illustrated in FIG. 44B, the information regarding the inspection object E includes a plurality of axes. Therefore, in the example of the present disclosure, the database 261a is a database having the object information that is the multidimensional information as an axis.

The database 261a may be represented in a tabular form. That is, a table in which suitable frequency parameters are described may be created as one record (row) for each piece of multidimensional information regarding the inspection object E. In a case where the database 261a is processed by a computer or the like, the database may be expressed in a tabular database, or may be expressed in a database format in which each piece of multidimensional information regarding the inspection object E is one record.

### (Frequency Selection)

FIG. 45 is a view schematically illustrating a configuration example of an operation screen 270 of the ultrasonic inspection device Z in the example of the present disclosure. The operation screen 270 is displayed on the display device 3 (FIG. 43) by the display unit 263 (FIG. 43). As described above, the display unit 263 displays, on the display device 3, a frequency spectrum 271 corresponding to the frequency component converted by the frequency conversion unit 230 (FIG. 43) and the input section 272 that receives input of the frequency parameter by the user. In the example of the present disclosure, the display unit 263 displays the operation screen 270 of the ultrasonic inspection device Z on the display device 3, and displays the frequency spectrum 271 and the input section 272 on the operation screen 270. Thus, the user can operate the input section 272 while checking the operation screen 270 including the frequency spectrum 271.

In the example illustrated in FIG. 45, the image 273 indicating the position of the defect portion D of the inspection object E is displayed on the left side. The frequency spectrum 271 is displayed in the upper right part. Here, it is preferable to be able to display the frequency spectrums 271 at a plurality of locations depending on the inspection position because comparison can be made. In particular, the frequency spectrum 271 includes a first frequency spectrum indicated by the broken line and a second frequency spectrum indicated by the solid line. The broken line and the solid line are the broken line and the solid line, respectively, in FIG. 12 and the like. Due to this, the user can compare the frequency spectra, and the user can input an appropriate frequency component. However, the frequency spectrum 271 to be displayed may be only any one of the first frequency spectrum and the second frequency spectrum. When the user has a certain degree of experience, a suitable frequency parameter can be determined based on only any one of the frequency parameters.

The frequency parameter is input to the input section 272 by the user. In the example of the present disclosure, the input section 272 is a frequency selection section including a slide bar with adjustable length and position. The user can input a frequency range (frequency set) for extracting the signal feature by adjusting the length and position of the slide bar to a position corresponding to the frequency position of the frequency spectrum using, for example, a mouse, a keyboard, or the like as the slide bar. The frequency range input here is a frequency parameter. After input, an update button 274 is pressed to update the frequency spectrum 271.

The frequency spectrum 271 is preferably displayed, but needs not be displayed. When not displayed, for example, the imaging unit 262 determines, as the initial frequency parameter, the frequency parameter corresponding to the information regarding the inspection object E received from the database 261a (FIG. 43) through an input section 275. The input section 275 receives information (the above-described “information regarding the inspection object E”) affecting the detection accuracy of the defect portion D in the inspection object E. The display unit 263 displays the input section 275 on the display device 3. When there is no corresponding frequency parameter, a frequency parameter corresponding to information closest to the information is determined. The determined frequency parameter is displayed on the display device 3. The imaging unit 262 creates the image 273 (FIG. 45. Defect image) based on the determined frequency parameter. Examples of the image 273 include the first defect image and second defect image. The detection accuracy of the defect portion D can be improved by using the information of the database 261a.

### Twelfth Embodiment

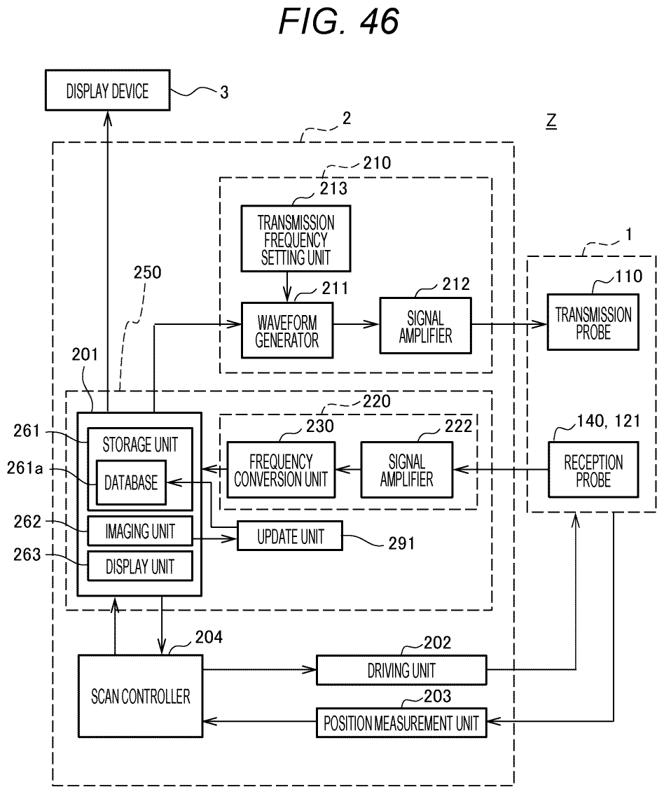

FIG. 46 is a functional block diagram of the ultrasonic inspection device Z of the twelfth embodiment. In the present embodiment, the input section 275 (FIG. 45) needs not be included.

The signal processing unit 250 includes an update unit 291 (frequency parameter update unit). The update unit 291 automatically updates the frequency parameter. An example of more specific processing in the update unit 291 will be described. The imaging unit 262 calculates the signal feature while changing the frequency parameter for the two reception signals of the defect portion D and the normal portion N. Then, the update unit 291 searches for and determines a frequency parameter in which the difference between the signal features of the defect portion D and the normal portion N is, for example, maximum (not limited to the maximum, and may be any size as long as the defect portion D can be detected). The imaging unit 262 creates the image 273 using the frequency parameter updated by the update unit 291 in this manner. The frequency parameter thus updated is registered in the database 261a, and the database 261a is updated.

Note that it is more preferable that the excitation frequency fex used for the frequency parameter is added to and saved in the database 261a. Therefore, the database 261a preferably includes information on the excitation frequency fex. Since the detectability of the defect portion D varies depending on how high the excitation frequency fex is shifted from the natural frequency fres of the transmission probe, it is possible to select an appropriate excitation frequency fex at the time of subsequent measurement by registering this in the database 261a.

Note that when the used excitation frequency fex is registered as the frequency parameter, the shift amount from the natural frequency fres is so important that the shift amount is preferably registered in the form of a difference amount Δfex=fex−fres. Furthermore, it is preferable to register a ratio (Δfex/fres) between the difference amount Δfex and the natural frequency fres.

Note that the determined frequency parameter may be displayed on the display device 3. In place of automatically updating the frequency parameter by the update unit 291, the user may designate the frequency parameter through the input section 272 while viewing the image 273. This also can further improve the detection accuracy of the defect portion D.

### Thirteenth Embodiment

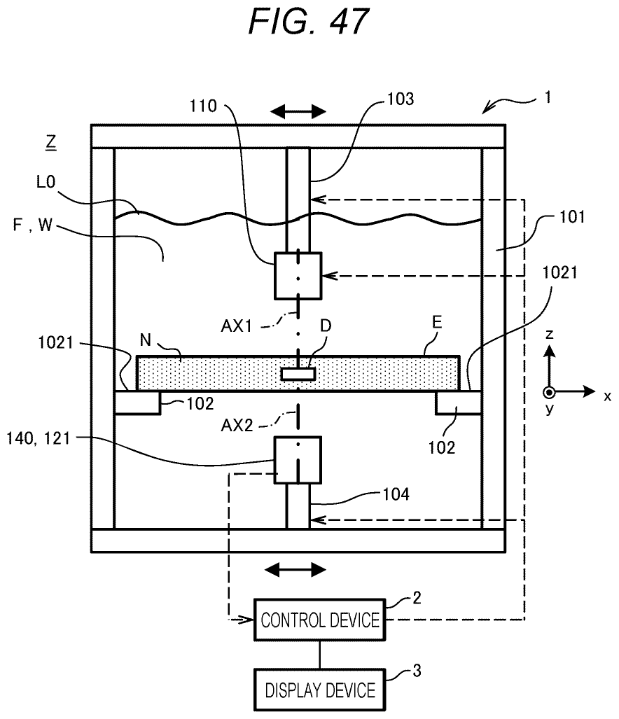

FIG. 47 is a view illustrating the configuration of the ultrasonic inspection device Z of the thirteenth embodiment. In the thirteenth embodiment, the fluid F is the liquid W, and is water in the illustrated example. The ultrasonic inspection device Z inspects the inspection object E by injecting the ultrasonic beam U to the inspection object E via the liquid W, which is the fluid F. The inspection object E is disposed below a liquid level L0 of the liquid W and is immersed in the liquid W.

Similarly to the first embodiment, in the present embodiment, the excitation frequency fex is set to a frequency shifted from the natural frequency fres of the transmission probe 110. Therefore, the scanning measurement device 1 drives the transmission probe 110 at the excitation frequency fex shifted from the natural frequency fres (synonymous with the resonance frequency) of the transmission probe 110. By setting the excitation frequency fex to an appropriate value, the performance of the ultrasonic inspection device Z of the present embodiment can be improved.

Note that the fluid F may be the gas G (FIG. 1) as described above, or may be the liquid W (FIG. 47) as in the present embodiment. However, when the gas G such as air is used as the fluid F, a more preferable effect is obtained as described above.

As described above, in the case where the gas G is used as the fluid F, it is more difficult to reduce the beam size of the ultrasonic beam U, and therefore the effect of the present disclosure can be obtained more effectively. As described above, the present disclosure can obtain a more preferable effect when the gas G is used as the fluid F.

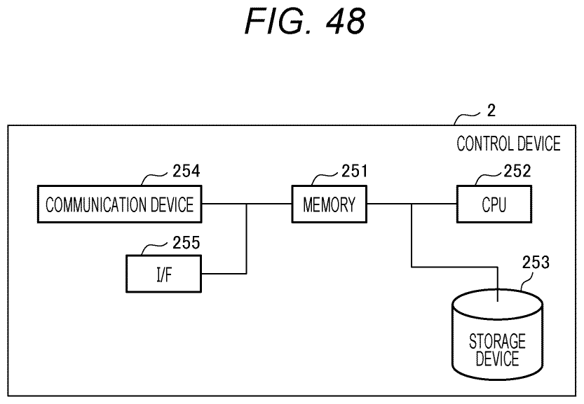

FIG. 48 is a view illustrating the hardware configuration of the control device 2. Some or all of the above-described configurations, functions, units constituting the block diagrams, and the like may be implemented by hardware by designing them with an integrated circuit, for example. As illustrated in FIG. 48, each of the above-described configurations, functions, and the like may be implemented by software by a processor such as a CPU 252 interpreting and executing a program for implementing each function. The control device 2 includes, for example, a memory 251, the CPU 252, a storage device 253 (SSD, HDD, or the like), a communication device 254, and an I/F 255. Information such as a program, a table, and a file for implementing each function can be stored in a recording device such as a memory and a solid state drive (SSD) or a recording medium such as an integrated circuit (IC) card, a secure digital (SD) card, and a digital versatile disc (DVD) in addition to a HDD.

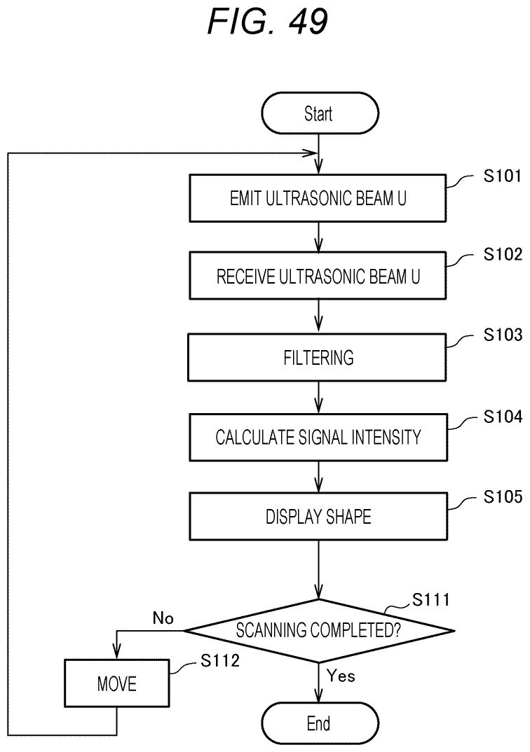

FIG. 49 is a flowchart showing the ultrasonic inspection method of each embodiment. The ultrasonic inspection method of the present disclosure can be executed by the control device 2 of the ultrasonic inspection device Z described above, and will be appropriately described with reference to FIGS. 1 and 10 as an example. In the ultrasonic inspection method of the present disclosure, the inspection object E is inspected by injecting the ultrasonic beam U to the inspection object E (FIG. 1) via the gas G (FIG. 1. Example of the fluid F). Note that although an embodiment in which the gas G is used as the fluid F in the ultrasonic inspection method will be described, it goes without saying that the ultrasonic inspection method is also effective for an embodiment in which the liquid W is used as the fluid F.

The ultrasonic inspection method of the present disclosure includes steps S101 to S105, S111, and S112. First, in accordance with a command from the control device 2, the transmission probe 110 of a line focus type performs step S101 (emission step) of emitting the ultrasonic beam U from the transmission probe 110.

In step S101, the transmission probe 110 is excited at the excitation frequency fex higher than the natural frequency fres (synonymous with the resonance frequency) of the transmission probe 110, and the ultrasonic beam U is emitted.

Subsequently, in step S102 (reception step), the reception probe 121 receives the ultrasonic beam U.

Thereafter, the filter unit 240 performs step S103 (filtering step) of reducing a component (maximum intensity frequency component) in a specific frequency range, specifically, a frequency range including the maximum component frequency fm, based on the signal (e.g., the waveform signal) of the ultrasonic beam U received by the reception probe 121. That is, in step S103, the maximum intensity frequency component of the signal of the ultrasonic beam U received in step S102 is reduced.

Then, the data processing unit 201 performs step S104 (signal intensity calculation step) of detecting the skirt component W3 of the fundamental waveband W1 from the filtered signal and generating signal intensity data (calculating signal intensity). Therefore, in step S104, the skirt component W3 of the fundamental waveband W1 in the signal of the ultrasonic beam U is detected. As a generation method of the signal intensity data, a peak-to-peak signal is used in the present embodiment. This is the difference between the maximum value and the minimum value of the signals.

Next, step S105 (shape display step) is performed. The scanning position information of the transmission probe 110 and the reception probe 121 is transmitted from the position measurement unit 203 to the scan controller 204. The data processing unit 201 plots signal intensity data at each scanning position with respect to the scanning position information of the transmission probe 110 acquired from the scan controller 204. In this way, the signal intensity data is imaged. This is step S105.

Note that FIG. 12 illustrates a case where the scanning position information is one-dimensional (one direction), and in a case where the scanning position information is two-dimensional of x and y, the defect portion D is illustrated as a two-dimensional image by plotting signal intensity data, and the two-dimensional image is displayed on the display device 3.

The data processing unit 201 determines whether or not scanning is completed (step S111). If the scanning is completed (Yes), the control device 2 ends the processing. If the scanning is not completed (No), the data processing unit 201 outputs a command to the driving unit 202 to move the transmission probe 110 and the reception probe 121 to the next scanning position (step S112), and returns the processing to step S101.

According to the ultrasonic inspection device Z and the ultrasonic inspection method described above, the inspection time required to detect the defect portion D can be significantly sped up, and the detection performance of the defect portion D, for example, the performance of detecting a minute defect can be improved.

In each of the above embodiments, an example in which the defect portion D is a cavity is described, but the defect portion D may be a foreign substance in which a material different from the material of the inspection object E is mixed. Also in this case, since there is a difference (gap) in acoustic impedance at the interface where different materials are in contact with each other, the scattering wave U1 is generated, and therefore the configuration of each of the above embodiments is effective. The ultrasonic inspection device Z according to each of the above embodiments is assumed to be an ultrasonic defect video device, but may be applied to a non-contact in-line internal defect inspection device.

The present disclosure is not limited to the above-described embodiments, and includes various modifications. For example, the above-described embodiments have been described in detail for easy understanding of the present disclosure, and are not necessarily limited to those having all the described configurations. A part of the configuration of a certain embodiment can be replaced with the configuration of another embodiment, and the configuration of another embodiment can be added to the configuration of a certain embodiment. Another configuration can be added to, deleted from, or replaced with a part of the configuration of each embodiment.

In each embodiment, control lines and information lines considered to be necessary for description are illustrated, and not all control lines and information lines for a product are necessarily illustrated. In practice, almost all configurations may be considered to be interconnected.

### REFERENCE SIGNS LIST

1 scanning measurement device
100 transmission probe
105 distance adjustment unit
106 installation angle adjustment unit
110 transmission probe
1100 virtual element
1101 unit probe
1102 unit probe
119 transmission probe
120 reception probe
121 reception probe
122 reception probe
130 long axis
131 scan axis
140 reception probe
2 control device
201 data processing unit
202 driving unit
203 position measurement unit
204 scan controller
210 transmission system
2100 defect detection region
2101 defect detection region
2102 defect detection region
211 waveform generator
212 signal amplifier
213 transmission frequency setting unit
220 reception system
222 signal amplifier
223 display unit
224 reception unit
230 frequency conversion unit
231 signal intensity calculation unit
240 filter unit
241 frequency component conversion unit
242 frequency selection unit
243 frequency component inverse conversion unit
244 detection unit
245 determination unit
250 signal processing unit
261a database
262 imaging unit
263 display unit
270 operation screen
271 frequency spectrum
272 input section
273 image
274 update button
275 input section
291 update unit
3 display device
300 acoustic wave shielding member
4 input device
AX transmission sound axis
AX1 transmission sound axis surface
AX2 reception sound axis
AX3 transmission sound axis
D defect portion
E inspection object
S sweep area
U ultrasonic beam
W1 fundamental waveband
W2 frequency range
W3 skirt component

1. An ultrasonic inspection device that performs inspection of an inspection object by causing an ultrasonic beam to be inject on the inspection object via a fluid, the ultrasonic inspection device comprising:
a scanning measurement device that performs scanning and measurement of the ultrasonic beam on the inspection object; and a control device that controls drive of the scanning measurement device,
wherein the scanning measurement device includes
a transmission probe of a line focus type that emits the ultrasonic beam, and a reception probe that receives the ultrasonic beam, the reception probe being installed on an opposite side of the transmission probe with respect to the inspection object,
the transmission probe emits an ultrasonic beam by being applied with a voltage waveform of a periodic wave packet including a wave packet having a wavenumber of equal to or greater than 2, and
drives the transmission probe at an excitation frequency higher than a resonance frequency 41 the transmission probe,
the control device includes a signal processing unit,
the signal processing unit includes a filter unit that reduces at least a maximum intensity frequency component of a reception signal of the reception probe, and
the filter unit detects a skirt component other than the maximum intensity frequency component in a fundamental waveband including the maximum intensity frequency component.

2. The ultrasonic inspection device according to claim 1, wherein an angle formed by a long axis that is an axis of a longest part in a convergence portion of the ultrasonic beam emitted from the transmission probe and a scan axis that is a scanning direction of the transmission probe is equal to or greater than 60° and equal to or less than 120° with respect to the scanning direction.

3. The ultrasonic inspection device according to claim 1, wherein a focal length of the reception probe is longer than a focal length of the transmission probe.

4. The ultrasonic inspection device according to claim 1, wherein the reception probe is a non-convergent reception probe.

5. The ultrasonic inspection device according to claim 1, wherein a full-width of half maximum of a frequency spectrum of the fundamental waveband is equal to or less than 50% of a maximum component frequency that is a frequency corresponding to the maximum intensity frequency component.

6. The ultrasonic inspection device according to claim 1, wherein
the filter unit includes
a frequency component conversion unit that converts a reception signal of the reception probe into a frequency component, and
a frequency selection unit that selects the skirt component by removal of a frequency band including the maximum intensity frequency component.

7. The ultrasonic inspection device according to claim 1, wherein the excitation frequency is set in a frequency range of the fundamental waveband.

8. The ultrasonic inspection device according to claim 1, wherein a wavenumber of the wave packet is 30 or less.

9. The ultrasonic inspection device according to claim 1, wherein an absolute value of a difference between the excitation frequency and the resonance frequency is equal to or less than 25% of a maximum component frequency, which is a frequency corresponding to the maximum intensity frequency component.

10. The ultrasonic inspection device according to claim 1, wherein an absolute value of a difference between the excitation frequency and the resonance frequency is equal to or less than 15% of a maximum component frequency, which is a frequency corresponding to the maximum intensity frequency component.

11. The ultrasonic inspection device according to claim 1, wherein a frequency detected by the filter unit includes a frequency in a range of (fm±0.25 fm), where fm is a maximum component frequency, which is a frequency corresponding to the maximum intensity frequency component.

12. The ultrasonic inspection device according to claim 1, wherein the scanning measurement device includes a transmission probe of a point focus type that emits the ultrasonic beam.

13. The ultrasonic inspection device according to claim 12, wherein a defect detection region where a defect signal is detected by scanning the transmission probe of a line focus type is scanned by the transmission probe of a point focus type, and a defect portion is imaged.

14. The ultrasonic inspection device according to claim 1, wherein the fluid is a gas.

15. An ultrasonic inspection that performs inspection of an inspection object by causing an ultrasonic beam to be inject on the inspection object via a fluid, the ultrasonic inspection device comprising:
a scanning measurement device that performs scanning and measurement of the ultrasonic beam on the inspection object; and a control device that controls drive of the scanning measurement device,
wherein the scanning measurement device includes
a transmission probe of a line focus type that emits the ultrasonic beam, and a reception probe that receives the ultrasonic beam, the reception probe being installed on an opposite side of the transmission probe with respect to the inspection object, and
a distance adjustment unit that adjusts an eccentric distance between a transmission sound axis surface of the transmission probe and a reception sound axis of the reception probe to a distance greater than zero.

16. An ultrasonic inspection device that performs inspection of an inspection object by causing an ultrasonic beam to be inject on the inspection object via a fluid, the ultrasonic inspection device comprising:
a scanning measurement device that performs scanning and measurement of the ultrasonic beam on the inspection object; and a control device that controls drive of the scanning measurement device,
wherein the scanning measurement device includes
a transmission probe of a line focus type that emits the ultrasonic beam, and a reception probe that receives the ultrasonic beam, the reception probe being installed on an opposite side of the transmission probe with respect to the inspection object, and
an acoustic wave shielding member that shields an ultrasonic beam from the transmission probe toward the reception probe is included on a transmission sound axis surface of the transmission probe between the inspection object and the reception probe.

17. The ultrasonic inspection device according to claim 1, wherein a distance between a transmission sound axis surface of the transmission probe and a reception sound axis of the reception probe is larger than zero.

18. The ultrasonic inspection device according to claim 1, wherein
the transmission probe of a line focus type includes a plurality of unit probes of a line focus type,
a transmission sound axis surface of each of the unit probes is arranged to be shifted in a scan axis direction, and
parts of the transmission sound axis surfaces of the unit probes overlap in front view of the transmission sound axis surface.

19. An ultrasonic inspection method of performing inspection of an inspection object by causing an ultrasonic beam to be inject on the inspection object via a fluid, the ultrasonic inspection method comprising:
an emitting step of emitting an ultrasonic beam by exciting a transmission probe at an excitation frequency higher than a resonance frequency of the transmission probe of a line focus type;
a receiving step of receiving the ultrasonic beam;
a filtering step of reducing a maximum intensity frequency component of a signal of the ultrasonic beam received in the receiving step; and
a signal intensity calculating step of detecting a skirt component of a fundamental waveband in a signal of the ultrasonic beam.

20. The ultrasonic inspection device according to claim 15, wherein
the transmission probe of a line focus type includes a plurality of unit probes of a line focus type,
a transmission sound axis surface of each of the unit probes is arranged to be shifted in a scan axis direction, and
parts of the transmission sound axis surfaces of the unit probes overlap in front view of the transmission sound axis surface.
